(19) United States
(12) Patent Application Publication
(10) Pub. No.: US 2013/0268306 A1
(43) Pub. Date: Oct. 10, 2013

(54) SCHEDULE ARRANGEMENT SYSTEM AND METHOD FOR TRIPS MATCHING, INTEGRATION AND OUTPUT

(71) Applicant: XADURO INC., Tauyuan County (TW)

(72) Inventors: Chih-Pin Tai, Tauyuan County (TW); Shiau-Jing Ding, Tauyuan County (TW)

(73) Assignee: Xaduro Inc., Tauyuan County (TW)

(21) Appl. No.: 13/856,237

(22) Filed: Apr. 3, 2013

(30) Foreign Application Priority Data
Apr. 5, 2012 (TW) 101112117
Apr. 5, 2012 (TW) 101112118
Apr. 5, 2012 (TW) 101112122
Apr. 5, 2012 (TW) 101112123

(51) Int. Cl. G06Q 10/02

(52) U.S. Cl. CPC G06Q 10/025
USPC 705/6

(57) ABSTRACT

The present invention provides a schedule arrangement system and a method for trips matching, integration and output, the schedule arrangement system includes at least one information of an itinerary displaying board displaying an itinerary; a general displaying module displaying the general; a geographic displaying module displaying geographic; and at least an interaction existing thereamong for assisting the users in completing their schedule plans. In one embodiment, the schedule arrangement system further includes a matching system. In another embodiment, the schedule arrangement system further includes an integration system of schedule arrangement and resource reservation. In still another embodiment, the schedule arrangement system further includes a personalized travel information automatic output system.

### CROSS-REFERENCE TO RELATED APPLICATION AND CLAIM OF PRIORITY

The application claims the benefit of the Taiwan Patent Application Nos. 101112117, 101112118, 101112122 and 101112123, filed on Apr. 5, 2012, in the Taiwan Intellectual Property Office, the disclosures of which are incorporated herein in their entirety by reference.

### TECHNICAL FIELD

The present invention relates to a schedule arrangement system and a method for trips matching, integration and output, and more particularly to a schedule arrangement system for travel system.

### BACKGROUND

Tourism is a kind of leisure activities away from the land of the daily life, it allows people to get away from the workplace or everyday life locations, and therefore get rid of working pressure and/or interpersonal stress. The tourists journey to relax and enjoy the service of others. Thus, all along, tourism is recognized as the most conducive activity to relax and relieve the pressure.

As improved living standards and weekends policy, public demand for travel will also increase. In the traditional business mode, consumers can only select the planned trip by the travel agency, and the trip is often unable to meet the travel needs of all, and can not be customized for the scenic spots and accommodation. In addition, with the prevalence of self-service travel, the consumers can decide the itinerary more arbitrarily and get rid of the shackles of a tour group for the entire trip. Therefore, the “Packages” planned by the travel agency are difficult to meet the demand of the consumers. Thus, the development of customized, personalized travel plan will be the trend of the future.

In the current travel site, the schedule is often arranged by placing tourist destinations in a shopping cart (buffer) first, and then the scenic spots in the shopping cart are arranged in an itinerary. However, for many days trip, it needs that a day schedule has been arranged, and then the next day schedule can be arranged. Therefore, when the user has decided the date of going to a tourist spot, but not decided the time, the tourist spot is just placed in the shopping cart first. When the time to go to many tourist spots has not been determined, it will cause the cart added in many tourist spots with undetermined time. Thus the number of tourist spots in the shopping cart and chaotic sequence are adverse for the user to plan an itinerary.

Besides, in the general travel site, the itinerary only display the order of the various tourist spots, without the corresponding spending time, which cause the user ignore the time required by each tourist spot in the scheduled itinerary, and thus result in excessive tourist spots but unable to go to, or compression time of each tourist spot.

In order to overcome the drawbacks in the prior art, a schedule arrangement system and a method for trips matching, integration and output are provided. The particular design in the present invention not only solves the problems described above, but is also easily implemented. Thus, the present invention has the utility for industry.

### SUMMARY

In accordance with one aspect of the present disclosure, a method for matching information is provided. The method includes steps of receiving a first specific parameter corresponding to a first group of travel objects, receiving a first public parameter, and performing a first calculating operation to generate a second group of travel objects based on the first specific parameter and the first public parameter.

In accordance with another aspect of the present disclosure, a reserving method is provided. The method includes steps of arranging a schedule, obtaining a resource corresponding to the schedule, and performing a reservation for the resource while arranging the schedule or after finishing the schedule.

In accordance with one more aspect of the present disclosure, a travelling information outputting method is provided. The method includes steps of receiving a travelling information, obtaining an output content describing the travelling information, selecting an output medium, and transforming the output content on the output medium.

The above objectives and advantages of the present invention will become more readily apparent to those ordinarily skilled in the art after reviewing the following detailed descriptions and accompanying drawings.

### BRIEF DESCRIPTION OF THE DRAWINGS

FIG. 1(a) illustrates a diagram of a schedule arrangement system of an embodiment of the present invention;

FIG. 1(b) illustrates a diagram of the interactive relationship among the itinerary displaying board, the general information displaying module and the geographic information displaying module;

FIG. 2 illustrates a one-day itinerary in accordance with an embodiment of the present invention;

FIG. 3(a) illustrates a daily itinerary in accordance with an embodiment of the present invention;

FIG. 3(b) is a schematic diagram illustrating the planning of the sub-day itinerary in accordance with an embodiment of the present invention;

FIG. 4 is a diagram of an itinerary information screen in accordance with an embodiment of the present invention;

FIG. 5 is the schematic diagram of planning transport path in accordance with an embodiment of the present invention;

FIG. 6 illustrates a schedule arrangement system in accordance with another embodiment of the present invention;

FIG. 7 illustrates an information matching system in accordance with an embodiment of the present invention;

FIG. 8(a) illustrates a diagram of a first interface 2202 of an interface unit of the information matching device in accordance with an embodiment of the present invention;

FIG. 8(b) illustrates a diagram of a second interface of an interface unit of the information matching device in accordance with an embodiment of the present invention;

FIG. 8(c) illustrates a diagram of the second interface of an interface unit in accordance with an embodiment of the present invention;

FIG. 9 illustrates a flow chart of a processing unit of the information matching device in accordance with an embodiment of the present invention;

FIG. 10(a) illustrates a diagram of a first configuration of a travel system of the information matching device in accordance with an embodiment of the present invention;

FIG. 10(b) illustrates a diagram of a second configuration of the travel system of the information matching device in accordance with an embodiment of the present invention;

FIG. 11 illustrates a schedule arrangement system in accordance with another embodiment of the present invention;

FIG. 12 illustrates a flow chart of the schedule arrangement and resource reservation integration system in accordance with an embodiment of the present invention;

FIG. 13 illustrates a flow chart of the schedule arrangement and resource reservation integration system in accordance with another embodiment of the present invention;

FIG. 14 illustrates a flow chart of the schedule arrangement and resource reservation integration system in accordance with another embodiment of the present invention;

FIG. 15(a) illustrates a schedule arrangement system in accordance with another embodiment of the present invention;

FIG. 15(b) illustrates a flow diagram showing a personalized travel information automatic output system according to the first to the third embodiments of the present invention;

FIG. 16(a) illustrates a block diagram showing a personalized travel information automatic output system according to the fourth embodiment of the present invention;

FIG. 16(b) illustrates a flow diagram showing a personalized travel information automatic output system according to the fourth embodiment of the present invention;

FIG. 17(a) illustrates a block diagram showing a personalized travel information automatic output system according to the fifth embodiment of the present invention; and

FIG. 17(b) illustrates a flow diagram showing a personalized travel information automatic output system according to the fifth embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

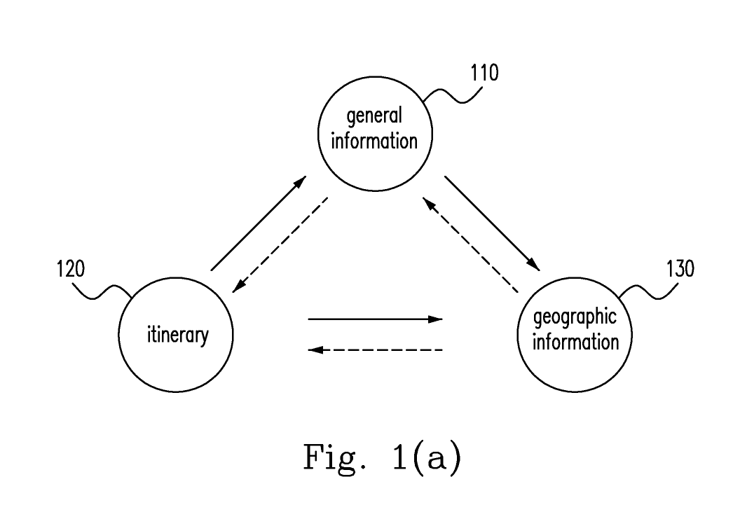

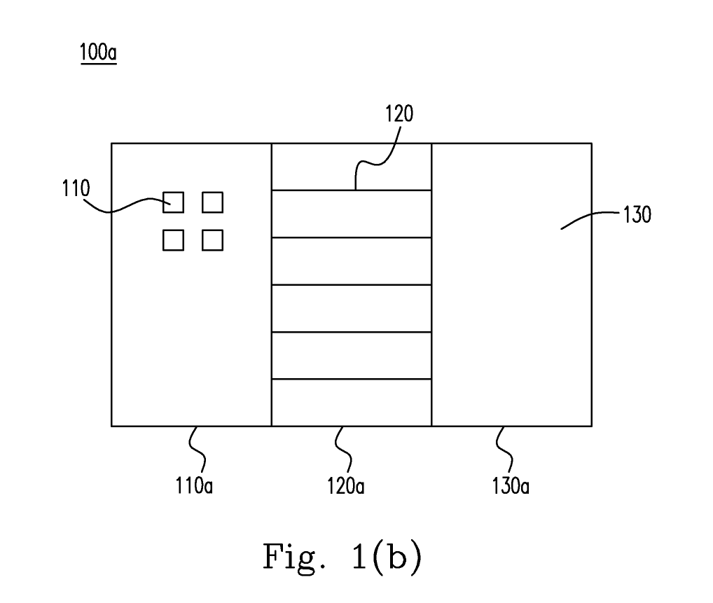

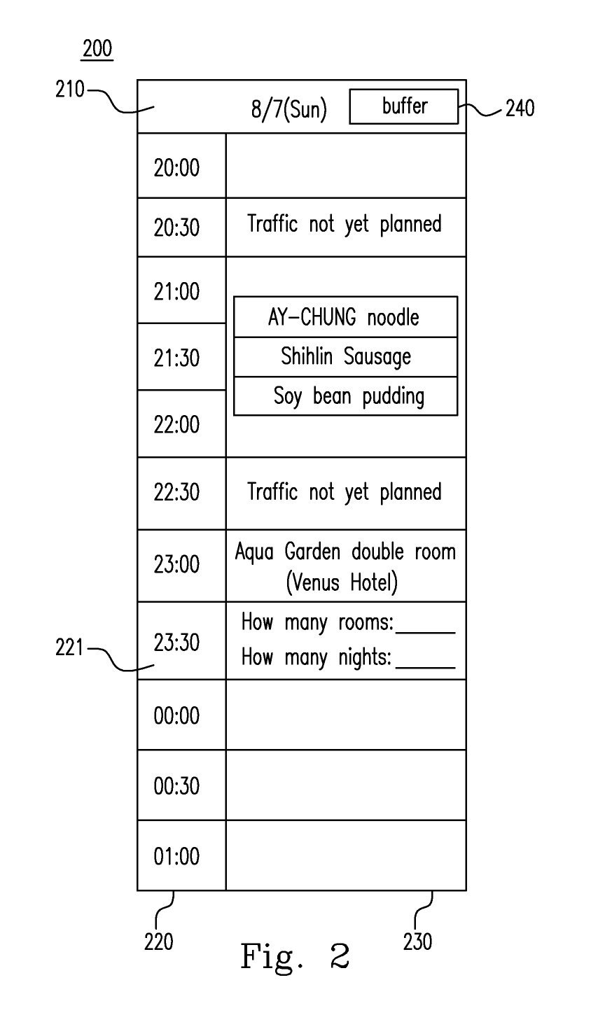

Please refer to FIG. 1(a), illustrating a diagram of a schedule arrangement system 100a of an embodiment of the present invention. The schedule arrangement system 100a includes an itinerary displaying board 120a, a general information displaying module 110a, a geographic information displaying module 130a and at least an interaction. The itinerary displaying board 120a is used to display an itinerary 120, the general information displaying module 110a is used to display a general information 110, the geographic information displaying module 130a is used to display a geographic information 130, and the at least an interaction occurs among the itinerary displaying board 120a, the general information displaying module 110a and the geographic information displaying module 130a to assist a user to complete the operation of the itinerary. Please refer to FIG. 1(b), which is a diagram of the interactive relationship among the itinerary displaying board, the general information displaying module and the geographic information displaying module. In FIG. 1(b), the general information 110, the itinerary 120 and the geographic information 130 will generate different interactive relationships between any two of them according to a user's selection. For example, clicking on the general information 110, the itinerary 120 and/or the geographic information 130 will display the screen related to the clicked the general information 110; clicking on the itinerary 120, the general information 110 and/or the geographic information 130 will display the screen related to the clicked the itinerary 120; and clicking on the geographic information 130, the general information 110 and/or the itinerary 120 will display the screen related to the clicked the geographic information 130. The present invention provides a planning method of an itinerary for the user planning an itinerary conveniently. The present invention provides a one-day itinerary 200, as shown in FIG. 2. The one-day itinerary includes a date field 221 for displaying a date, a time list 222 and a plurality of fields 223, wherein the time list 222 includes plural periods 224, these periods correspond to the fields 223 respectively, and these fields 223 allow users to drag a trip message in, including a tourist information and/or a business information. The time list can contain an arbitrary time interval to be the minimum time period, e.g., 15 minutes, 30 minutes, 1 hour or two hours, etc. and the period may be in units of hours, minutes or seconds. In the present embodiment, 30 minutes is a minimum period in the time list, and the period can be set across different days (e.g., from 23:45 to 00:15). The user can place a trip message in the field corresponding to a certain period, and adjust the time spent by the trip message. If a trip message overlaps another trip message, the itinerary 200 will adjust the positions of the trip message and the other trip message to make them non-overlapped. The date field 221 further includes a buffer 225, and the buffer allows users to drag a trip message in, to temporarily store the trip message. When the trip message is determined to go to at a certain period, the trip message can be placed in the field corresponding to the desired period.

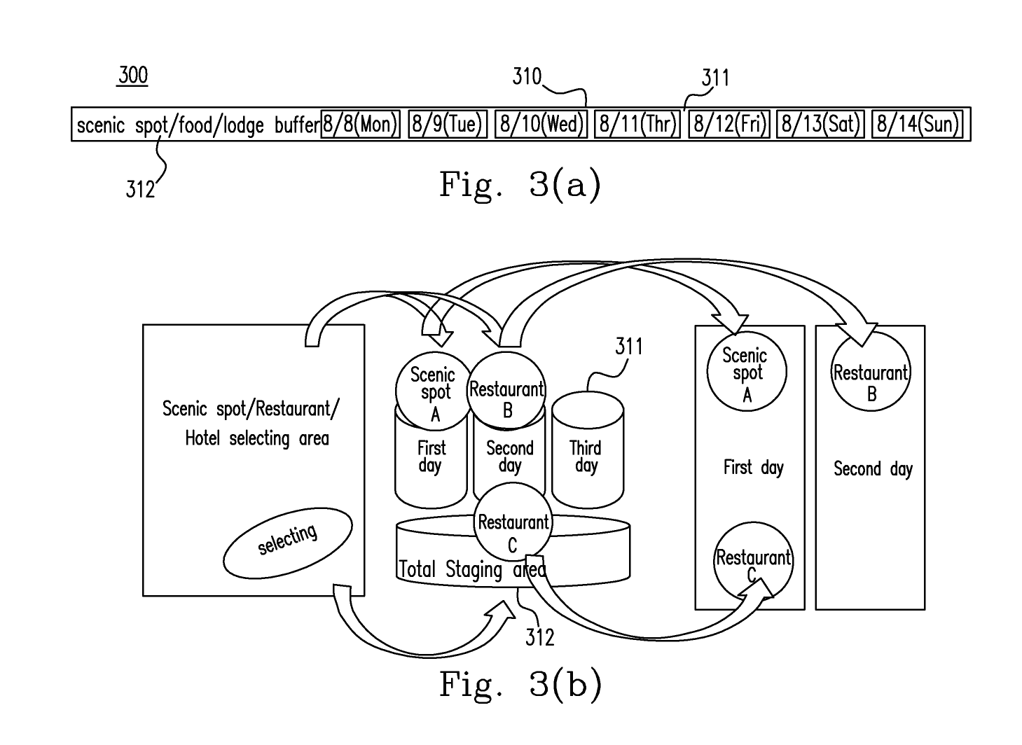

The present invention provides a daily itinerary 300, as shown in FIG. 3(a). The daily itinerary 300 displays a date list 310, the date list 310 includes a plurality of date regions 311 and a general buffer 312, the date regions 311 are one-day itinerary, the date regions 311 and the general buffer 312 allow users to drag trip messages in, wherein the trip messages include a tourist information and/or a business information. Please refer to FIG. 3(b), when the user has not determined the date bound for a tourist spot in the trip message, the trip message can temporarily stored in the general buffer 312; when the user has determined the date bound for the tourist spot in the trip message, but has not determined the time bound for, the trip message can temporarily stored in the date region 311 corresponding to the determined date; after the user has determined the date or the time bound for the tourist spot in the trip message, the trip message can be placed in the corresponding date region 311 or the field 223. When the number of the specific trip message exceeds a certain threshold, another itinerary displaying board is generated.

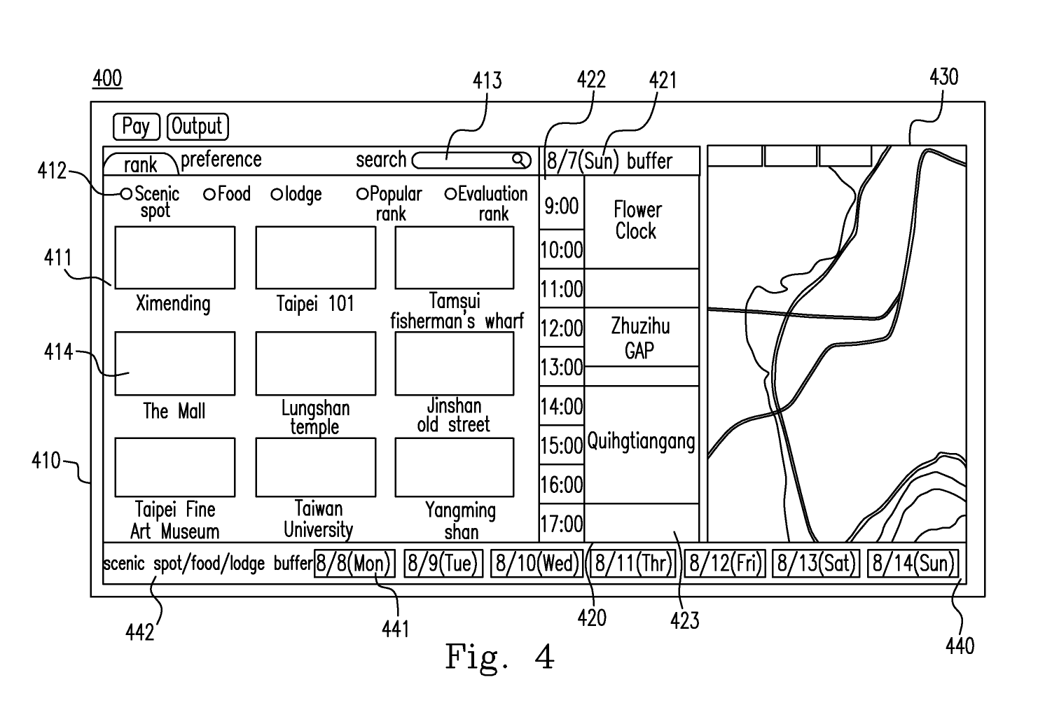

Please refer to FIG. 4, which is a diagram of an itinerary information screen of the present invention. The electronic device receives the trip messages clicked or input by the user to make the itinerary information screen to display different screens before and after the click or input. In FIG. 4, the itinerary information screen 400 can display a trip message board 410, an itinerary 420, a geographic information board 430 and a daily itinerary 440. The trip message board 410 includes a trip message list 411, a conditions list 412 and a search field 413. The trip message list 411 includes a plurality of trip messages 414 for the user to select. The conditions list 412 is provided for the user to select the desired browsing information. The search field 413 is provided for the user to input a keyword. The itinerary 420 is a one-day itinerary which includes a date field 421 for displaying a date, a time list 422 and a plurality of fields 423, wherein the time list 422 includes plural periods, these periods correspond to the fields 423 respectively, and these fields 423 allow users to drag trip messages in. The geographic information board 430 includes a map, which can show different geographic locations according to the trip message 414 selected by the user. The daily itinerary 440 displays a date list 441 including a plurality of date regions and a general buffer 442. The date regions and the general buffer 442 allow the user to place the trip message in a date region according to an appropriate date bound for a tourist spot in the trip message, and then to place the trip message in an itinerary field according to an appropriate period bound for a tourist spot in the trip message. When the user clicks on the trip message he/she wants to browse, the itinerary information screen will display the itinerary and at least one of a geographic information and a general information related to the trip message, and then the user drags the at least one trip messages into the itinerary according to the desired bound for location. The trip messages in the one-day itinerary, date region and general buffer 442 can be moved arbitrarily or removed therefrom.

The trip message in the present invention include, but are not limited to at least one of a travel itinerary information, a business schedule information and a manufacturing schedule information.

The trip message in the present invention is selected from a group consisting of a regional name, a location, an address, a drink name, a name of food, a name of commodity, a transportation way, a traffic route, an activity, a command, a keyword, a figure, an itinerary, a ticket, a resource and a combination thereof.

The geographic information in the present invention includes a map, an electronic map, a 3D map, a satellite map, a street-view map, a topographic map, a diagram of traffic condition, a weather diagram, a transportation route map, a high-speed railway route map, a train route map, a passenger transport roadmap, a bus roadmap, a MRT route map, a subway route map, a bicycle lane diagram, a flight roadmap, a navigation roadmap, and a combination thereof.

The general information of the present invention includes an industrial and commercial information, a utilities information, a cultural and educational work information, a transportation construction information, a leisure and shopping information, a scenic spot information, a government authority information, a delicacies information, a health care information, an arts and cultural information and an accommodation information. The industrial and commercial information includes at least one information of a trade union organization, various walks of life, a real estate, a social welfare agency and a financial institution. The utilities information includes at least one information of a gas station, an electricity company and a telecommunication. The cultural and educational work information includes at least one information of a bookstore, a cram school, a library and a school. The transportation construction information includes at least one information of a public transportation, a major road construction, a vehicle maintenance plant, a towing field and a parking lot. The leisure and shopping information includes at least one information of a life shopping, an entertainment, and an audio-visual entertainment. The scenic spot information includes at least one information of a natural ecological attraction, a festival activity, a theme park, a tourist night market, a bicycle lane, a landmark building, a railway, a farm and a park. The government authority information includes at least one information of a central authority, a local authority, a foreign agency and a gendarmerie/police/fire fighting. The delicacies information includes at least one information of a Chinese cuisine, a Japanese cuisine, a hot pot/BBQ, a variety of snacks, a buffet, a Western-style cuisine, an entertainment dining, a tea/ice snack, a exotic cuisine and a self-cultivation vegetarian. The health care information includes at least one information of a health center, an animal hospital, a clinic, a hospital, a drug store and a pharmacy. The arts and cultural information includes at least one information of a studio (such as an art classroom, a dance studio, a studio, a design studio), a Hakka culture, a hierarchical monument, a religion, a memorial, an exhibition hall, a museum, a museum of fine arts and an art center. The accommodation information includes at least one information of a hotel (such as star tourist hotels, leisure hotels, business hotels, resort hotels, budget hotels, spa hotels, a motel, a pet hotel, a youth hostel, etc.), a B&B, a farm, a camping venue, and a hotel-style apartment.

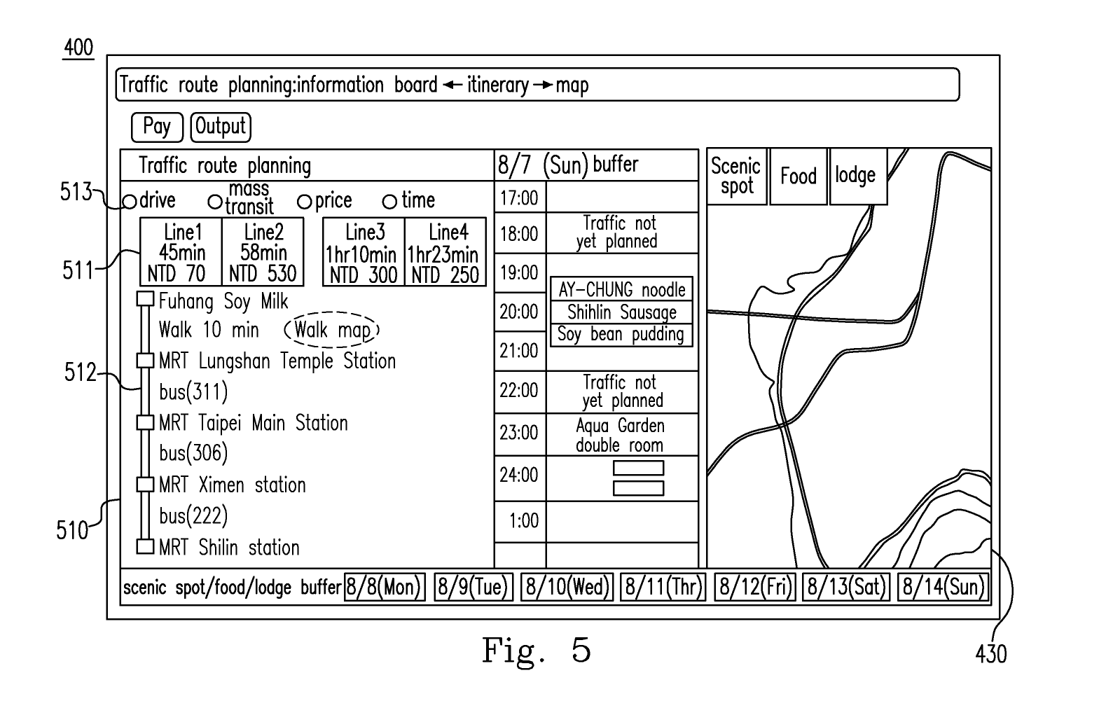

Please refer to FIG. 5, which is the schematic diagram of planning transport path of the present invention. The itinerary information screen of the present invention further includes a traffic route planning window 510, which includes a path menu 511 and a preference list 513. The path menu 511 displays one or more of the time and the price menu for user to choose a route depending on the time and the price. The traffic route planning window 510 will display different traffic routes according to the selection of the preference transportation way, the cost or the spent time made by the user. When a route is clicked, the traffic route planning window 510 displays a route planning diagram 512, and the map 520 will show the roadmap of the route.

### Embodiment 1

When the user wants to search for location information, the user can fill in the search field with the site location (for example: Longshan Temple) on the trip message board of the itinerary information screen. The itinerary information screen will proceed search according to the location that the user inputs to find out the tourist spot and the map related to Longshan Temple and the peripheral circumstance thereof. In this location information related to Longshan Temple and the peripheral circumstance thereof (for example: Guangzhou Street Night Market), the user can click on one of the location information (for example: Longshan Temple). Then the trip message board in the itinerary information screen displays the picture related to Longshan Temple, and the map will search the geographic location of Longshan Temple according to the clicked message. The user can also clicks on a site location (for example: Huaxi Street Night Market), and the trip message board in the itinerary information screen will display the picture related to Huaxi Street Night Market.

### Embodiment 2

When the user wants to search for delicacies, the user can fill in the search field with the delicacies information (for example: pasta restaurant) on the trip message board of the itinerary information screen. The itinerary information screen will proceed search according to the delicacies information that the user inputs to find out the information and the map related to the delicacies. In this delicacies information related to pasta restaurant (for example: La leone pasta), the user can click on one of the delicacies information (for example: the branch store of La leone pasta in National Taiwan Normal University). Then the trip message board in the itinerary information screen displays the picture related to the branch store of La leone pasta in National Taiwan Normal University, and the map will search the geographic location thereof according to the clicked message.

### Embodiment 3

When the user wants to search for accommodation information, the user can fill in the search field with the accommodation information (for example: Grand Hotel) on the trip message board of the itinerary information screen. The itinerary information screen will proceed search according to the accommodation information that the user inputs to find out the information and the map related to Grand Hotel. In this accommodation information related to Grand Hotel and the peripheral circumstance thereof (for example: Shihlin Night Market), the user can click on one of the accommodation information (for example: Grand Hotel). Then the trip message board in the itinerary information screen displays the picture related to Grand Hotel, and the map will search the geographic location of Grand Hotel according to the clicked message.

### Embodiment 4

When the user wants to search for location information, but does not know where to search, the user can click on the trip message list on the trip message board of the itinerary information screen. The trip message list displays the location information of more multiple clicks, being popular and good evaluation. If the user prefers some location information (for example: Ximending), and clicks thereon, the itinerary information screen displays the picture related to Ximending, and the map will search the geographic location of Ximending according to the clicked message.

### Embodiment 5

When the user wants to search for delicacies information, but does not know what to search, the user can click on the trip message list on the trip message board of the itinerary information screen. The trip message list displays the delicacies information of more multiple clicks, being popular and good evaluation. If the user prefers some delicacies information (for example: hell ramen), and clicks thereon, the itinerary information screen displays the picture related to hell ramen, and the map will search the geographic location of hell ramen according to the clicked message.

### Embodiment 6

When the user wants to search for accommodation information, but does not know what hotel to search, the user can click on the trip message list on the trip message board of the itinerary information screen. The trip message list displays the accommodation information of more multiple clicks, being popular and good evaluation. If the user prefers some accommodation information (for example: Grand Hyatt), and clicks thereon, the itinerary information screen displays the picture related to Grand Hyatt, and the map will search the geographic location of Grand Hyatt according to the clicked message.

### Embodiment 7

When the user wants to search for the delicacies in Taichung Gongyi Road, the user can click on the map on the itinerary information screen to enlarge the map focused on Taichung Gongyi Road. In the process of the click by the user, the information of the trip message is altered on the trip message board according to the click by the user. The user can click on any location on the map (for example: STEAK AKAONI), and then the itinerary information screen will proceed search according to the location clicked by the user and displays the pictures and the related information related to STEAK AKAONI in the trip message board.

### Embodiment 8

When the user searches for travel information (for example: Yangming mountain) and fills in the search field with Yangming mountain in the trip message board of the itinerary information screen, the itinerary information screen will proceed search according to Yangming mountain input by the user to find out the information related to Yangming mountain and display a one-day itinerary. The user can click the attraction information (for example: Xiaoyou Keng) related to Yangming mountain or the peripheral circumstance thereof. After clicking on the trip message, the trip message board in the itinerary information screen will search according to the clicked message to find out the picture of Xiaoyou Keng. If the user wants to do the sightseeing in Xiaoyou Keng, the user can drag the trip message of Xiaoyou Keng into the one-day itinerary. When the user has dragged many trip messages into the one-day itinerary, the user can further click on the trip message (for example: Zhú Z\check{i} Lake) in the one-day itinerary, and the trip message board in the itinerary information screen will search for Zhú Z\check{i} Lake clicked by the user to find out the information related to Zhú Z\check{i} Lake.

### Embodiment 9

When the user wants to use the map to search for tourist attractions, the user can click the map to zoom in the map to the desired location (for example: Cingjing farm). Then the map in the itinerary information screen displays the map of Cingjing farm and the peripheral circumstance thereof and displays a one-day itinerary. The user can click the trip message of Cingjing farm in the map (for example: Little Swiss Garden). After clicking the trip message, the map in the itinerary information screen will search according to the clicked message to find out the geographic information related to Little Swiss Garden. If the user want to do the sightseeing in Little Swiss Garden, the user can drag the trip message of Little Swiss Garden into the one-day itinerary. The user can further click on the trip message (for example: Qingqing grassland) in the one-day itinerary, and the map in the itinerary information screen will search according to the trip message clicked by the user to find out the geographic information related to Qingqing grassland.

### Embodiment 10

When the user wants to plan a one-day tour, the user can fill in the search fields with the interest location and interest delicacies (for example: Taipei 101 or any places) in the trip message board of the itinerary information screen. The itinerary information screen will proceed search according to the location that the user inputs to find out the tourist spot (for example: the Warner Village Cinema or JOGOYA) and the map related to Taipei 101 or any places and the peripheral circumstance thereof, and display a one-day itinerary. The user can click the attraction message related to Taipei 101 or any places and the peripheral circumstance thereof (for example: the Warner Village Cinema or JOGOYA). After clicking the trip message, the map in the itinerary information screen will search for the geographic location of the Warner Village Cinema or JOGOYA according to the clicked message. The user can select a trip message (for example: Taipei 101 or any places) in the itinerary information screen, and drag the trip message into the corresponding itinerary field of interest period in the one-day itinerary to generate a customized one-day tourist itinerary. The user can also click the trip message (for example: Eslite flagship store) according to the trip message on the map, and the trip message board in the itinerary information screen will search for the information related to Eslite flagship store according to Eslite flagship store clicked by the user. If the user is interested in going to, the user can drag the trip message of Eslite flagship store into the corresponding itinerary field of interest period in the one-day itinerary. When there are several trip messages placed in the itinerary field of the one-day itinerary, the user can click on one of the trip message (for example: Shin Kong Mitsukoshi). The itinerary information screen will proceed search according to Shin Kong Mitsukoshi clicked by the user in the itinerary, and the tourist spot and the geographic information related to Shin Kong Mitsukoshi and the peripheral circumstance thereof are displayed on the trip message board and the map to look up the related information of Shin Kong Mitsukoshi.

### Embodiment 11

When the user wants to plan a multi-day tour itinerary, the user can fill in the search fields with the interest location, interest delicacies and interest accommodation in the trip message board of the itinerary information screen. If the user still has no idea about the interest location, interest delicacies and interest accommodation, the general information of more clicks, popularity, excellent evaluation provided by the trip message board can be utilized. After searching, the itinerary information screen will display a trip message list, a one-day itinerary, a map and a sub-day itinerary. The user can drag one of the trip messages into the one-day itinerary according to the trip messages displayed on the trip message board of the itinerary information screen. If the user wants to go to a location (for example: Feng Chia Night Market) but have not yet decided on what day to go, the trip message of Feng Chia Night Market can be dragged into the buffer of the sub-day itinerary first. If the user wants to eat a delicacy (for example: Ding spicy hot pot) and has decided to eat in a specific day, but has not decided which period to go on the specific day, the trip message of Ding spicy hot pot can be dragged into a certain date region in the sub-day itinerary. After the period of going to Feng Chia Night Market or Ding spicy hot pot is determined, the trip message of Feng Chia Night Market or Ding spicy hot pot is dragged into the corresponding itinerary field. When the user has decided what date to go to Feng Chia Night Market, but has not decided which period to go to, Feng Chia Night Market in the buffer can be dragged into a certain date region in the sub-day itinerary. If the user has decided which period to go to Feng Chia Night Market, the trip message of Feng Chia Night Market can be directly dragged into the itinerary field of the corresponding period in the one-day itinerary. If the user has decided which period to go to Ding spicy hot pot, the trip message of Ding spicy hot pot can be dragged into the itinerary field of the corresponding period in the one-day itinerary. If the user wants to change the trip messages in the one-day itinerary, the trip messages originally placed in the one-day itinerary can be moved to the sub-day itinerary or the buffer, and the user can adjust the spent time by each of the trip messages or remove directly in the one-day itinerary to generate the customized multi-day tour itinerary.

### Embodiment 12

When the user wants to plan a one-day or multi-day business itinerary, the user can fill in the search field with the bound for location (for example: Taipei city council) on the trip message board or click on the location on the map of the itinerary information screen. The itinerary information screen will proceed search according to the filled or clicked location to find out the tourist spot and the map related to Taipei city council and the peripheral circumstance thereof, and display a one-day itinerary and a sub-day itinerary. The user can click the attraction message related to Taipei city council and the peripheral circumstance thereof (for example: the ShenYi branch store of Eslite). After clicking the attraction message, the map in the itinerary information screen will search for the geographic location of the ShenYi branch store of Eslite according to the clicked message. The user can select a trip message (for example: Taipei city council) in the itinerary information screen, and drag the trip message into the corresponding itinerary field of interest period in the one-day itinerary, or put the trip message temporarily in the buffer or a certain date region. After the time of the itinerary is determined, the trip message in the buffer or date region is moved into the corresponding itinerary field. The user can adjust the spent time by each of the trip messages in the one-day itinerary to generate customized one-day or multi-day business itinerary.

### Embodiment 13

When the user wants to plan a multi-day international traveling itinerary, the user can fill in the search field with the bound for location (for example: Hong Kong) on the trip message board or click on the location on the map of the itinerary information screen. The itinerary information screen will proceed search according to the filled or clicked location to find out the geographic information and the general information of Hong Kong, and display a one-day itinerary and a sub-day itinerary. The user can click the geographic information and the general information related to Hong Kong (for example: Hong Kong Disneyland). After clicking the attraction message, the trip message board in the itinerary information screen will search for the picture of Hong Kong Disneyland according to the clicked message, and the map will search for the geographic location of Hong Kong Disneyland according to the clicked message. The user can select at least a trip message (for example: Hong Kong Disneyland, Hong Kong Ocean Park) in the itinerary information screen, and drag the trip message into the corresponding itinerary field of interest period in the one-day itinerary, or put the trip message temporarily in the buffer or a certain date region. After the time of the itinerary is determined, the trip message in the buffer or date region is moved into the corresponding itinerary field. The user can adjust the spent time by each of the trip messages in the one-day itinerary to generate customized one-day or multi-day international traveling itinerary.

### Embodiment 14

When a one-day itinerary or a multiple-day itinerary has been determined, but the traffic route of the schedule has not been planned, the user may click “traffic not yet planned” in the itinerary. The itinerary information screen displays a traffic route planning window, which is based on different traffic ways to arrange multiple traffic routes, wherein the traffic routes display the needed time and fees. When clicking one of the traffic routes, the traffic route planning window displays the route plan of the traffic route, and the traffic route is displayed on the map simultaneously. The user may click the preferred traffic way or traffic fee or traffic time in the preference list. The system displays the proper traffic route on the traffic route planning window based on the user's preference so as to provide the most suit traffic route for the user to choose.

### Embodiment 15

The user has planned to leave the Cesar Park at 9:00 am, go to the National Taiwan Science Education Center at 9:30-12:00 am, lunch at the Kyoto Romance Meiji restaurant at 12:30-1:30 pm, go to the National palace museum at 2:00-5:30 pm, have dinner at Shihlin Night Market at 5:30-9:30 pm and go back to the Cesar Park at 10:00 pm. When the user clicks “traffic not yet planned” in the itinerary, the system plans 4 traffic routes and displays them on the traffic route planning window of the itinerary information screen, wherein the traffic route 1 needs about 100 minutes and 90 dollars, traffic route 2 needs about 120 minutes and 110 dollars, traffic route 3 needs about 100 minutes and 470 dollars and traffic route 4 needs about 90 minutes and 950 dollars. When the user clicks traffic route 2, the itinerary information screen displays the traffic route of the traffic route 2 (walk from the Cesar Park to the MRT Taipei station (2 minutes and 0 dollar)→take MRT to the MRT Jiantan Station (10 minutes and 25 dollars)→take Red 30 or No. 41 bus to the National Taiwan Science Education Center (20 minutes and 15 dollars)→take Red 30, Red 12 or No. 620 bus to the MRT Shihlin Station (15minutes and 15 dollars)→walk to Kyoto Romance Meiji restaurant (3 minutes and 0 dollar)→take Red 30 bus to the National palace museum (30minutes and 15 dollars)→take Red 30 bus to the Shihlin Night Market (35 minutes and 15 dollars)→walk to the MRT Jiantan Station (6 minutes and 0 dollar)→take MRT to the MRT Taipei station (10 minutes and 25 dollars)→walk to the Cesar Park (2 minutes and 0 dollar)), and shows the route map of traffic route 2 on the map. When the user clicks one of the routes of the traffic route 2, such as walking to Kyoto Romance Meiji restaurant, the map of the itinerary information screen displays the walk itinerary map regarding walking to Kyoto Romance Meiji restaurant. If the user prefers to utilize traffic route 2 to reach the destination, he may click “choose the route” at the downward right corner at the traffic route planning window to arrange the traffic route of the schedule. The user may click the preferred transportation vehicles, prices and time length in the preference list, and the system arranges the traffic route based on the clicked requirements (such as the length of time) of the user, and the planned traffic route is displayed in an order based on the length of time, such that the user may choose based on his preference. If the user does not want the traffic route scheduled by the system, e,g. the user wants to drive by himself, the user may click “by car” in the preference list, and the system arranges the required time to each of the destinations by car, and the map of the itinerary information screen displays the itinerary by car, which is convenient for the user to drive to the destination. The user may adjust the start and leave time of the schedule based on the chosen traffic route.

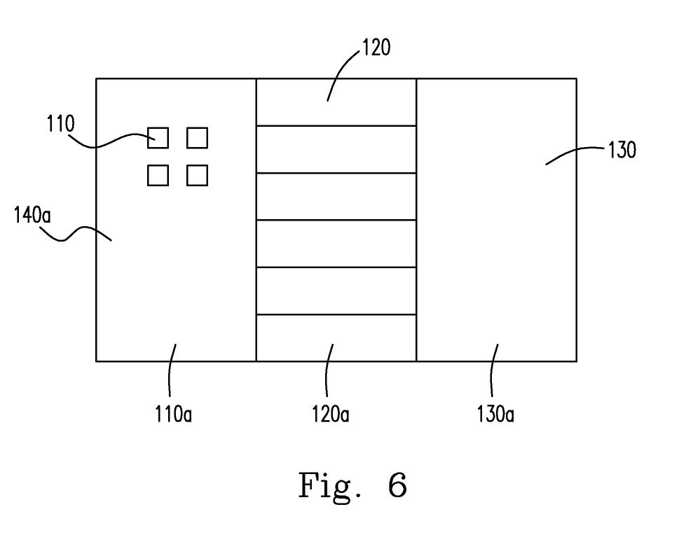

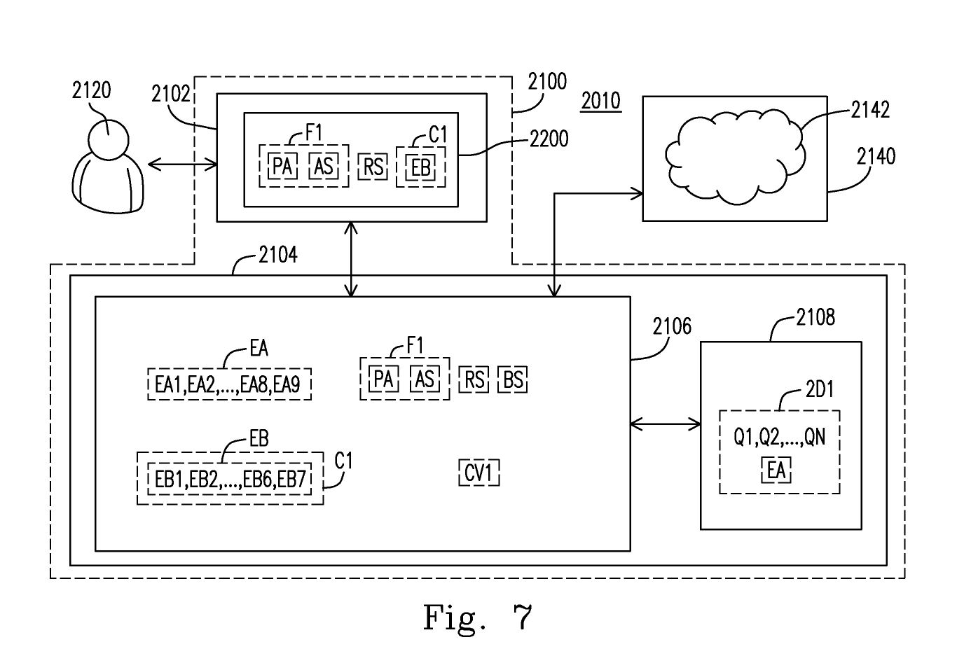

Please refer to FIG. 6, which illustrates a schedule arrangement system 100a in accordance with another embodiment of the present disclosure. In the embodiment, the schedule arrangement system 100a further includes an information matching system 140a, wherein the information matching system 140a changes the display way of the general information 110 based on the user's preference. Please refer to FIG. 7, which illustrates an information matching system 2010 in accordance with an embodiment of the present disclosure. The information matching system 2010 includes a device 2100 used for information matching, a user 2120 and a network 2140 coupled to the device 2100. For example, the information matching means generates a personalized information C1 matching the user's 2120 preference. The personalized information C1 includes at least one of objects, voices, images, etc., and the network 2140 includes an internet 2142. In an embodiment, the personalized information C1 is the general information 110. In another embodiment, the personalized information C1 is the schedule information 414.

The device 2100 includes an interface unit 2102 and a processing unit 2104 coupled to the interface unit 2102. The interface unit 2102 suggests an object attribute structure F1. The processing unit 2104 obtains a personalized preference parameter structure RS through the interface unit 2102. For example, the personalized preference parameter structure RS is corresponding to the object attribute structure F1. For example, the object attribute structure F1 has an object classification PA and a specific attribute structure AS used to define the object classification PA, wherein the personalized preference parameter structure RS personalizes the specific attribute structure AS. In an embodiment, the interface unit 2102 suggests the object attribute structure F1, receives the personalized preference parameter structure RS and provides the personalized preference parameter structure RS to the processing unit 2104, wherein the personalized preference parameter structure RS is input by the user 2120 and is used to provide the preference of the user 2120. The processing unit 2104 transforms the personalized preference parameter structure RS into a personalized preference parameter structure BS based on an arithmetic operation CV1. Those skilled in the art may appreciate that under the circumstance that the interface unit 2102 does not suggest the travel object attribute structure F1, the user may receive the personalized preference parameter structure RS through the interface unit 2102.

In an embodiment, the interface unit 2102 receives the personalized preference parameter structure RS, transforms the personalized preference parameter structure RS into the personalized preference parameter structure BS based on the arithmetic operation CV1, and provides the personalized preference parameter structure BS to the processing unit 2104.

In an embodiment, the processing unit 2104 selects from public information 2D1 based on the object attribute structure F1 to generate a first group EA of objects EA1, EA2, . . . EA8 and EA9. In an embodiment, the first group EA of objects EA1, EA2 . . . EA8 and EA9 have a first order, wherein the first order is random, or the first order is an order according to the popularity of the first group EA of objects EA1, EA2 . . . EA8 and EA9. In another embodiment, the first group EA of objects EA1, EA2 . . . EA8 and EA9 do not have an order, and are a combination of the plurality of objects. In an embodiment, the interface unit 2102 suggests a plurality of object classifications for the user 2120 to choose one of them as the object classification PA. For example, the processing unit 2104 selects from the public information 2D1 based on the object classification PA to generate the first group EA of objects EA1, EA2 . . . EA8 and EA9. Those skilled in the art may appreciate that the processing unit 2104 may also randomly obtain the first group EA of objects EA1, EA2 . . . EA 8 and EA9 without the selecting process.

Next, the processing unit 2104 obtains a first group of public evaluation parameter structure S1, S2 . . . SN from the network 2140, vendors or the combination thereof, wherein the first group of public evaluation parameter structure S1, S2 . . . SN is corresponding to the first group EA of objects EA1, EA2 . . . EA8 and EA9 and is predetermined by general users.

The processing unit 2104 performs an operation to generate a second group EB of objects EB1, EB2 . . . EB6 and EB7 with specific order, based on the personalized preference parameter structure BS and the first group of public evaluation parameter structure S1, S2 . . . SN, wherein the first group EA of objects EA1, EA2 . . . EA8 and EA9 contains the second group EB of objects EB1, EB2 . . . EB6 and EB7. That is to say, the processing unit 2104 reorders the original first group EA of objects EA1, EA2 . . . EA8 and EA9 to generate the personalized information C1, based on the personalized preference parameter structure RS set by the user 2120 and the first group of public evaluation parameter structure S1, S2 . . . SN, wherein the personalized information C1 contains the second group EB of objects EB1, EB2, . . . EB6 and EB7 with specific order. In an embodiment, the second group EB object is selected from the first group EA object. For example, the second group of EB object is an object mostly meeting the requirement of the personalized preference parameter structure RS.

In an embodiment, the processing unit 2104 contains a control unit 2106 and a database unit 2108 coupled to the control unit 2104, wherein the control unit 2106 is further coupled to the interface unit 2102 and the network 2104. In an embodiment, the public information 2D1 is obtained from the network 2140, vendors or combination thereof. In an embodiment, the public information 2D1 is stored in the database unit 2108; that is to say, the database unit 2108 has the public information 2D1, and the public information 2D1 includes a plurality of objects Q1, Q2 . . . QN. The control unit 2106 generates the first group EA of objects EA1, EA2 . . . EA8 and EA9 by selecting from the objects Q1, Q2 . . . QN based on the object attribute structure F1 chosen by the user 2120. For example, the plurality of objects Q1, Q2 . . . QN are a plurality of travel objects.

In an embodiment, the interface unit 2102 suggests an interface structure 2200, wherein the interface structure 2200 suggests the plurality of object classifications during a first period, and suggests the object attribute structure F1 used for inputting the personalized preference parameter structure RS during a second period. The control unit 2106 receives the object classification PA through the interface structure 2200 during the first period, and receives the personalized preference parameter structure RS through the interface structure 2200 during the second period. The control unit 2106 transforms the personalized preference parameter structure RS into the personalized preference parameter structure BS based on the arithmetic operation CV1. Next, the control unit 2106 obtains the first group of public evaluation parameter structure S1, S2 . . . SN through the network 2140, and reorders the first group EA of objects EA1, EA2 . . . EA8 and EA9 to generate the personalized information C1 containing the second group EB of objects EB1, EB2 . . . EB6 and EB7 based on the personalized preference parameter structure BS and the first group of public evaluation parameter structure S1, S2 . . . SN. The control unit 2106 sends the personalized information C1 to the interface unit 2102, and the interface unit 2102 displays the personalized information C1 to the user 2120.

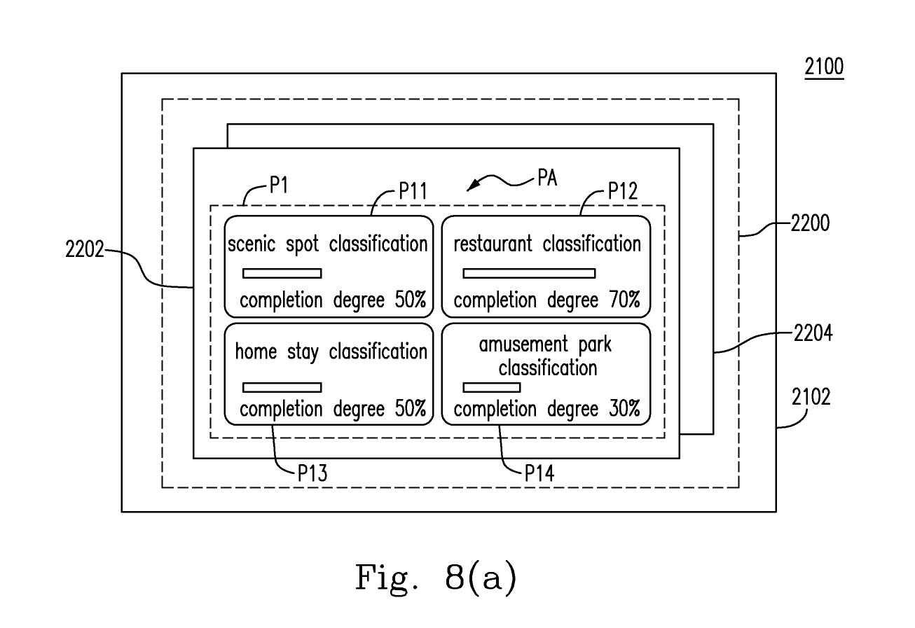

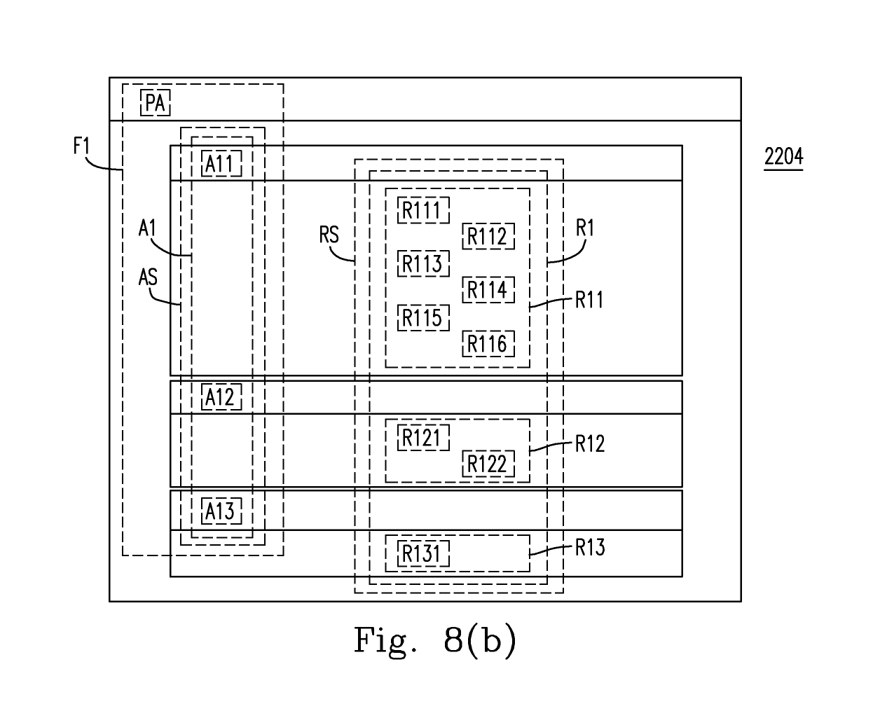

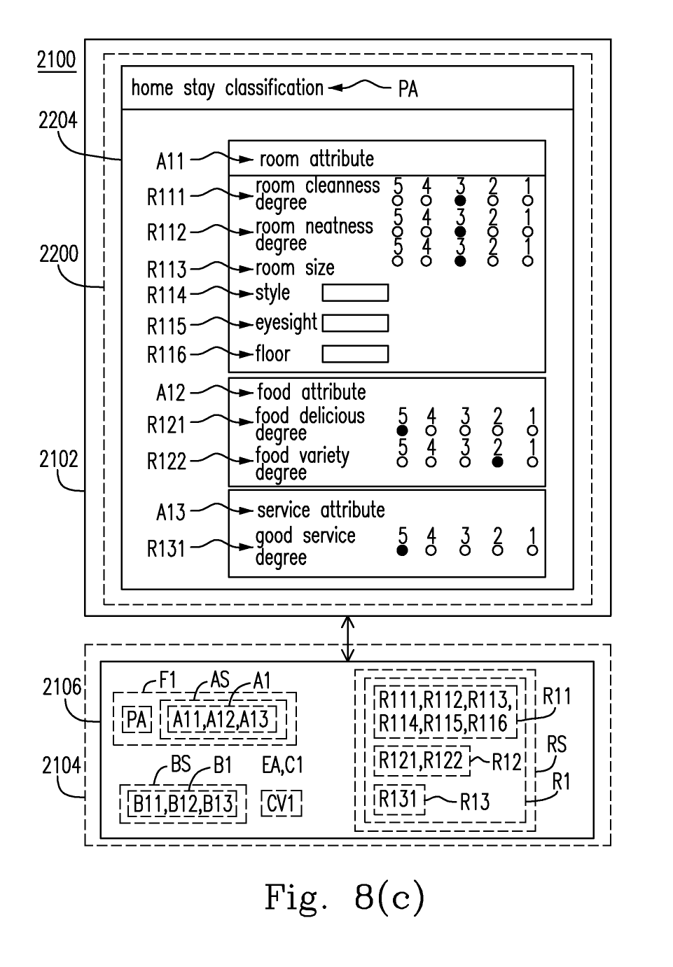

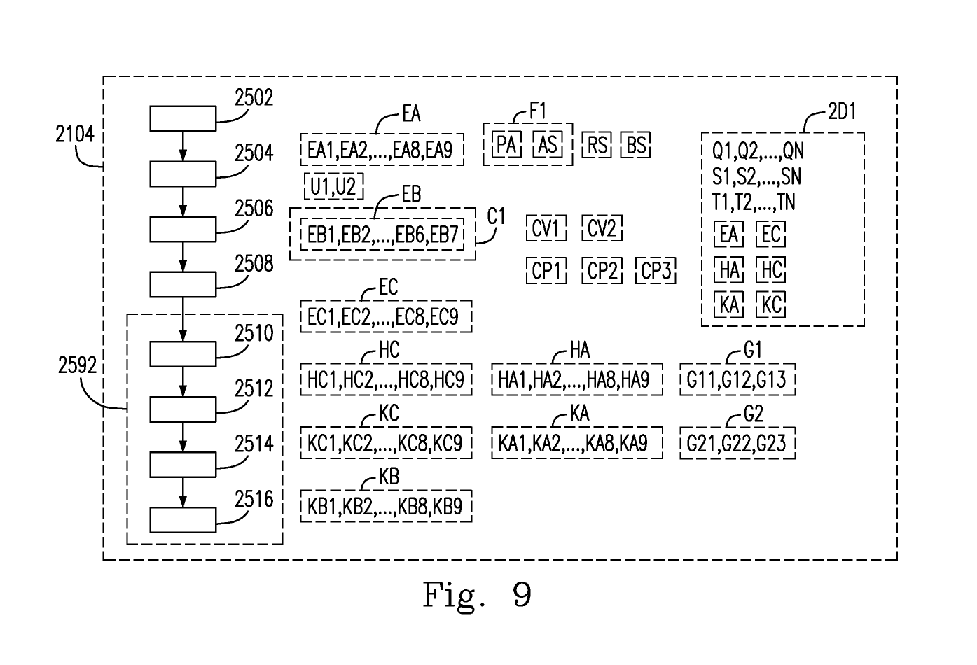

Please refer to FIGS. 8(a) and 8(b), wherein FIG. 8(a) illustrates a diagram of a first interface 2202 of an interface unit 2102 of the information matching device 2100 in accordance with an embodiment of the present disclosure, and FIG. 8(b) illustrates a diagram of a second interface 2204 of an interface unit 2102 of the information matching device 2100 in accordance with an embodiment of the present disclosure. The interface unit 2102 provides the interface structure 2200, and the interface structure 2200 contains the first interface 2202 and the second interface 2204 related to the first interface 2202, wherein the first interface 2202 suggests a object classification P1 for the user 2120 to choose the object classification PA.

For example, the object classification structure P1 contains a plurality of object classifications P11, P12 . . . P13 and P14. For example, the plurality of object classifications P11, P12 . . . P13 and P14 are a plurality of travel object classifications, which represents scenic spot classification, restaurant classification, home stay classification and amusement park classification, and the object classification PA may represent one of the plurality of object classifications P11, P12, P13 and P14 selected by the user 2120.

In an embodiment, the database unit 2108 obtains the object classification structure P1 in advance, and classifies the plurality of objects Q1, Q2 . . . QN in order according to the plurality of object classifications P11, P12 . . . P13 and P14. For example, a specific object of the plurality of objects Q1, Q2 . . . QN is classified into one of the plurality object classifications P11, P12, P13 and P14.

The first interface 2202 suggests the plurality of object classifications P11, P12, P13 and P14 for the user to choose the desired object classification, wherein the plurality of object classifications P11, P12, P13 and P14 are configured to describe the belonged classification of the plurality of object classifications P11, P12, P13 and P14. For example, the processing unit 2104 let the second interface 2204 suggest the object attribute structure F1 corresponding to the object classification PA, based on the object classification PA chosen by the user 2120.

For example, the specific attribute structure AS of the object attribute structure F1 contains a group A1 of object attributes A11, A12 and A13, or the group A1 of object attributes A11, A12 and A13. For example, the group A1 of object attributes A11, A12 and A13 may represent one of a group scenic spot attribute, a group home stay attribute, a group restaurant attribute and a group amusement park attribute. In FIG. 8(a), the first interface 2202 further suggests a plurality of input completion degree corresponding to the plurality of object classifications P11, P12, P13 and P14, respectively.

When the user 2120 chooses (may be clicked) the desired object classification PA through the first interface 2202, the interface unit 2102 provides the second interface 2204 as shown in FIG. 8(b). In an embodiment, the user 2120 chooses (may be clicked) the object classification P13 to let the object classification PA represent the object classification P13 (the home stay classification). The second interface 2204 suggests the object attribute structure F1 used for inputting the personalized preference parameter structure RS. For example, the personalized preference parameter structure RS contains a group R1 of personalized preference parameters R11, R12 and R13, or the group R1 of personalized preference parameters R11, R12 and R13.

For example, the group A1 of object attributes A11, A12 and A13 is corresponding to the group R1 of personalized preference parameters R11, R12 and R13, respectively. The personalized preference parameter R11 contains a group RG1 of sub-preference parameters R111, R112, R113, R114, R115 and R116, the preference parameter R12 contains a group RG2 of sub-preference parameters R121 and R122, and the preference parameter R13 contains a group RG3 of sub-preference parameter 131.

The control unit 2106 receives the personalized preference parameter structure RS corresponding to the specific attribute structure AS through the second interface 2204, wherein the personalized preference parameter structure RS represents the user's 2120 the preference degree of the specific attribute structure AS. In an embodiment, as shown in FIG. 8(b), the second interface 2204 suggests the object attribute structure F1 and has a parameter input interface; that is to say, the second interface 2204 suggests the object classification PA and the specific attribute structure AS. The parameter input interface is configured to let the user 2120 input the personalized preference parameter structure RS, or is configured to let the interface unit 2102 receive the personalized preference parameter structure RS.

Please refer to FIG. 8(c), which illustrates a diagram of the second interface 2204 of an interface unit 2102 in accordance with an embodiment of the present disclosure. As shown in FIG. 8(c), the group A1 of object attributes A11, A12 and A13 represent a room attribute, a food attribute and a service attribute, respectively. The group A1 of object attributes A11, A12 and A13 correspond to the group R1 of personalized preference parameters R11, R12 and R13, respectively. The group RG1 of sub-preference parameters R111, R112, R113, R114, R115 and R116 of the personalized preference parameter R11 represent the room cleanness degree, the room neatness degree, the room size, style, eyesight and floors. The group RG2 of sub-preference parameters R121 and R122 of the personalized preference parameter R12 represent the food delicious degree and the food variety degree. The group RG3 of sub-preference parameter R131 of the personalized preference parameter R13 represents the good service degree. For example, the personalized preference parameter structure BS contains a personalized preference parameter B11 or a group B1 of personalized preference parameters B11, B12 and B13.

In one embodiment, the control unit 2106 has the object attribute structure F1. One of the interface unit 2102 and the control unit 2106 transforms the group R1 of personalized preference parameters R11, R12 and R13 into the group B1 of personalized preference parameters B11, B12 and B13, based on the arithmetic operation CV1, wherein the group B1 of personalized preference parameters B11, B12 and B13 is corresponding to the group R1 of personalized preference parameter R11, R12 and R13.

Please refer to FIG. 8(c), for easy explanation, here merely considers the plurality of sub-preference parameters R111, R112, R113, R121, R122 and R131. In response to the user's input, the plurality of sub-preference parameters R111, R112, R113, R121, R122 and R131 have a plurality of parameter values 3, 3, 3, 5, 2 and 5, respectively. One of the interface unit 2102 and the control unit 2106 obtains the group B1 of personalized preference parameters B11, B12 and B13 by utilizing the following equations (1), (2) and (3) to get the mean value:

B11=(R111+R112+R113)/3=(3+3+3)/3 (1)

B12=(R121+R122)/2=(5+2)/2 (2)

B13=R131/1=5/1 (3)

Based on the equations (1), (2) and (3), the personalized preference parameter B11, B12 and B12, corresponding to the room attribute, the food attribute and the service attribute respectively, have 3 parameter values 3, 3.5 and 5, respectively.

In one embodiment, these sub-preference parameters R111, R112, R113, R114, R115, R116, R121, R122 and R131 received through the second interface 2204 have a plurality of predetermined values, respectively. For example, these sub-preference parameters R111, R112, R113, R114, R115, R116, R121, R122 and R131 have a specific sub-preference parameter, and the specific sub-preference parameter has a specific predetermined value. When the user 2120 does not provide the specific sub-preference parameter, one of the interface unit 2102 and the control unit 2106 considers the specific sub-preference parameter to have the specific predetermined value to perform the operation mentioned above.

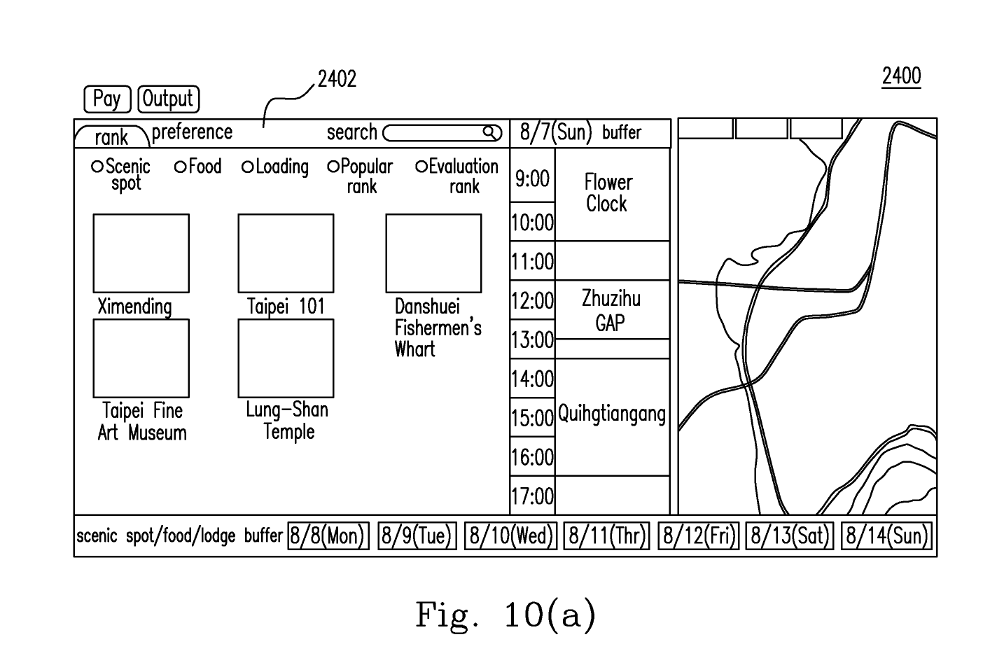

Please refer to FIG. 9, which illustrates a flow chart of a processing unit 2104 of the information matching device 2100 in accordance with an embodiment of the present disclosure. As shown in FIG. 9, in step 2502, the processing unit 104 obtains the public information 2D1 from the network 2140, vendors, or the combination thereof in advance.

For example, general users predetermine the plurality of objects Q1, Q2 . . . QN in the public information 2D1 to form the plurality of public evaluation parameter structures S1, S2 . . . SN and the plurality of public evaluation values T1, T2 . . . TN, wherein the plurality of public evaluation parameter structures S1, S2 . . . SN are corresponding to the plurality of objects Q1, Q2 . . . QN and the plurality of public evaluation values T1, T2 . . . TN are corresponding to the plurality of public evaluation parameter structures S1, S2 . . . SN. The public information 2D1 includes the plurality of public evaluation parameter structures S1, S2 . . . SN and the plurality of public evaluation values T1, T2 . . . TN. The processing unit 104 processes the plurality of public evaluation parameter structures S1, S2 . . . SN in advance to generate the plurality of public evaluation values T1, T2 . . . TN based on an arithmetic operation CV2.

For example, the plurality of public evaluation parameter structures S1, S2 . . . SN represent the structural public popularities of the plurality of objects Q1, Q2 . . . QN respectively, and the plurality of public evaluation values T1, T2 . . . TN represent the synthetic public popularities of the plurality of objects Q1, Q2 . . . QN respectively. For example, based on the respective average of each of the plurality of public evaluation parameter structures S1, S2 . . . SN, the plurality of public evaluation parameter structures S1, S2 . . . SN have a plurality of averages respectively, and the plurality of public evaluation values T1, T2 . . . TN are the plurality of averages, respectively.

In step 2504, the processing unit 2104 obtains the object classification PA of the object attribute structure F1 selected by the user 2120 through the interface unit 2102, wherein the object attribute structure F1 contains the object classification PA and the specific attribute structure AS used to define the object classification PA.

In step 2506, the processing unit 2104 obtains the object attribute structure F1 based on the object classification PA, and obtains the personalized preference parameter structure RS (the group R1 of personalized preference parameters R11, R12 and R13) set by the user through the interface unit 2102.

In step 2508, the processing unit 2104 generates a first group EA of objects EA1, EA2 . . . EA8 and EA9 from the public information 2D1 based on the object attribute structure F1 selected by the user 2120. In an embodiment, the first group EA of objects EA1, EA2 . . . EA8 and EA9 contains at least an object, the object attribute structure F1 has the object classification PA representing the object classification P13, and the first group EA of objects EA1, EA2 . . . EA8 and EA9 belongs to a group object of the object classification P13. For example, the first group EA of objects EA1, EA2 . . . EA8 and EA9 has the same object classification PA; that is to say, the object classification PA is related to the first group EA of objects EA1, EA2 . . . EA8 and EA9.

For example, the object attribute structure F1 represents a home stay attribute structure, the group A1 of object attributes A11, A12 and A13 represents a group home stay attribute, and the object classification P13 is a home stay classification. After the user 2120 selects the home stay classification, the processing unit 2104 obtains the object classification PA as the home stay classification from the interface unit 2102; next, the processing unit 2104 sifts all objects belonging to the home stay classification from the database unit 2108, the sifted objects serving as the first group EA of objects EA1, EA2 . . . EA8 and EA9.

In an embodiment, in step 2508, the processing unit 2104 sifts from the public information 2D1 to generate a third group EC of objects EC1, EC2 . . . EC8 and EC9, based on the object attribute structure F1, wherein the third group EC of objects EC1, EC2 . . . EC8 and EC9 is predetermined to form a group HC of public evaluation parameter structures HC1, HC2 . . . HC8 and HC9 corresponding to the third group EC of objects EC1, EC2 . . . EC8 and EC9, respectively. The processing unit 2104 generates a group KC of public evaluation values KC1, KC2 . . . KC8 and KC9 corresponding to the third group EC of objects EC1, EC2 . . . EC8 and EC9 based on the group HC of public evaluation parameter structures HC1, HC2 . . . HC8 and HC9, and reorders the third group EC of objects EC1, EC2 . . . EC8 and EC9 to generate the first group EA of objects EA1, EA2 . . . EA8 and EA9 based on the KC public of evaluation values KC1, KC2 . . . KC8 and KC9.

For example, the third group EC of objects EC1, EC2 . . . EC8 and EC9 are obtained from the plurality of objects Q1, Q2 . . . QN, the group HC of public evaluation parameter structures HC1, HC2 . . . HC8 and HC9 are obtained from the plurality of public evaluation parameter structures S1, S2 . . . SN, and the group KC of public evaluation values KC1, KC2 . . . KC8 and KC9 are obtained from the plurality of public evaluation values T1, T2 . . . TN.

In step 2592, the processing unit 2104 performs a first operation CP1 to generate a second group EB of objects EB1, EB2 . . . EB6 and EB7, based on the personalized preference parameter structure RS (or the group R1 of personalized preference parameters R11, R12 and R13) and the first group EA of objects EA1, EA2 . . . EA8 and EA9. For example, the processing unit 2104 transforms the personalized preference parameter structure BS into a personalized preference parameter structure BS, based on the arithmetic operation CV1, and reorders the first group EA of object EA1, EA2 . . . EA8 and EA9 to generate the personalized information C1 based on the personalized preference parameter structure, wherein the personalized information C1 contains the second group EB of objects EB1, EB2 . . . EB6 and EB7, and displays the personalized information C1 to the user 2120 through the interface unit 2102, wherein the order of the second group EB of object EB1, EB2 . . . EB6 and EB7 is displayed by the user's preference, and the object with higher preference is displayed first.

In an embodiment, the processing unit 2104 reorders the first group EA of objects EA1, EA2 . . . EA8 and EA9 to generate the second group EB of objects EB1, EB2 . . . EB6 and EB7, based on a first specific condition (such as the room cleanness degree) set by the user 2120, wherein the second group EB of objects EB1, EB2 . . . EB6 and EB7 meets the order required by the first specific condition.

For example, in step 2592, the processing unit 2104 further performs a relational analysis operation on the first group EA of objects EA1, EA2 . . . EA8 and EA9 to generate the second group EB of objects EB1, EB2 . . . EB6 and EB7, based on a second specific condition (such as the food flavor) set by the user 2120. For example, the user 2120 liking light food flavors often chooses the home stay object U1, and the user 2120 choosing the home stay object U1 often likes the home stay object U2. Thus, the processing unit 2104 enables the second group EB of objects EB1, EB2 . . . EB6 an EB7 to contain the home stay object U1 and the home stay object U2, and the home stay object U1 and the home stay object U2 are recommended to the user 2120 in high priority.

In an embodiment, step 2592 includes a plurality of steps 2510, 2512, 2514 and 2516. In step 2510, the processing unit 2104 transforms the personalized preference parameter structure RS (or the group R1 of personalized preference parameters R11, R12 and R13) into the personalized preference parameter structure BS (or the group B1 of personalized preference parameters B11, B12 and B13) corresponding to the specific attribute structure AS.

In step 2512, the processing unit 2104 retrieves a group HA of public evaluation parameter structures HA1, HA2 . . . HA8 and HA9 corresponding to the first group EA of objects EA1, EA2 . . . EA8 and EA9 respectively, and a group KA of public evaluation values KA1, KA2 . . . KA8 and KA9 corresponding to the group HA of public evaluation parameter structures HA1, HA2 . . . HA8 and HA9 respectively, wherein the group HA of public evaluation parameter structures HA1, HA2 . . . HA8 and HA9 represent the structural public popularity of the first group EA of objects EA1, EA2 . . . EA8 and EA9, and the group KA of public evaluation values KA1, KA2 . . . KA8 and KA9 represent the synthetic public popularity of the first group EA of objects EA1, EA2 . . . EA8 and EA9.

For example, the group HA of public evaluation parameter structures HA1, HA2 . . . HA8 and HA9 are obtained from the plurality of public evaluation parameter structures S1, S2 . . . SN, and the group KA of public evaluation values KA1, KA2 . . . KA8 and KA9 are obtained from the plurality of public evaluation values T1, T2 . . . TN. For example, each structure of the group HA of public evaluation parameter structures HA1, HA2 . . . HA8 and HA9 contains a respective group public evaluation parameter, and based on the average of the respective group, each respective public evaluation value of the group KA of public evaluation values KA1, KA2 . . . KA8 and KA9 is the average of the respective group public evaluation parameter corresponding to each respective public evaluation value in the group HA. For example, each structure of the group HA of public evaluation parameter structures HA1, HA2 . . . HA8 and HA9 has a first structure, the personalized preference parameter structure BS has a second structure, and the first structure is the same as the second structure.

For example, in step 2504, as shown in FIG. 8(a), the processing unit 2104 obtains the object classification PA selected by the user 2120 through the interface unit 2102, wherein the object classification PA represents the home stay classification.

For example, in step 2506, as shown in FIG. 8(c), the processing unit 2104 obtains the personalized preference parameter structure RS set by the user 2120 through the interface unit 2102.

For example, in step 2508, the processing unit 2104 retrieves the first group EA of objects EA1, EA2 . . . EA8 and EA9 from the public information 2D1. For example, the first group EA of objects EA1, EA2 . . . EA8 and EA9 represent all of the home stay objects respectively, wherein all of the home stay objects include the home stay object U1 and the home stay object U2, wherein the object EA1 and the object EA2 represent the home stay object U1 and the home stay object U2, respectively.

For example, in step 2510, the processing unit 2104 transforms the personalized preference parameter structure RS into the personalized preference parameter structure BS.

For example, in step 2512, the processing unit 2104 obtains the public evaluation parameter structure HAI corresponding to the object HA1 (or the home stay object U1) and the public evaluation value KA1 corresponding to the public evaluation parameter structure HA1 from the public information 2D1, and obtains the public evaluation parameter structure HA2 corresponding to the object EA2 (or the home stay object U1) and the public evaluation value KA2 corresponding to the public evaluation parameter structure HA2. For example, the public evaluation parameter structure HA1 is a group G1 of public evaluation parameters G11, G12 and G13, and the public evaluation parameter structure HA2 is a group G2 of public evaluation parameters G21, G22 and G33. The following list shows the objects EA1 and EA2, three public evaluation parameters G11, G12 and G13, three public evaluation parameters G21, G22 and G33, and two public evaluation values KA1 and KA2.

| | Public evaluation value |
|---|---|
| Object EA1 (home stay U1) | KA1: 3.77 |
| Public evaluation parameter G11 (room) | 4 |
| Public evaluation parameter G12 (food) | 3.5 |
| Public evaluation parameter G13 (service) | 3.8 |
| | Public evaluation value |
| Object EA2 (home stay U2) | KA2: 3.67 |
| Public evaluation parameter G21 (room) | 2 |
| Public evaluation parameter G22 (food) | 5 |
| Public evaluation parameter G23 (service) | 4 |

In an embodiment, the public evaluation value KA1 corresponding to the object EA1 (or the home stay U1) and the public evaluation value KA2 corresponding to the object EA2 (or the home stay U2) are generated by equations (4) and (5), respectively.

KA1=(G11+G12+G13)/3=(4+3.5+3.8)/3=3.77 (4)

KA2=(G21+G22+G23)/3=(2+5+4)/3=3.67 (5)

In step 2514, the processing unit 2104 operates a second operation CP2 to generate a group KB of personalized evaluation values KB1, KB2 . . . KB8 and KB9 corresponding to the first group EA of objects EA1, EA2 . . . EA8 and EA9, based on the personalized preference parameter structure BS and the group HA of public evaluation parameter structures HA1, HA2 . . . HA8 and HA9, wherein the group KB of personalized evaluation values KB1, KB2 . . . KB8 and KB9 represent the user's preference towards the first group EA of objects EA1, EA2 . . . EA8 and EA9. In an embodiment, the second operation CP2 is a weighted average operation. In another embodiment, the second operation CP2 is a relational analysis operation.

For example, in step 2514, the processing unit 2104 performs a weighted average operation to generate a group KB of personalized evaluation values KB1 and KB2 corresponding to the first group EA of travel objects EA1 (or the home stay object U1) and EA2 (or the home stay object U2), based on the personalized preference parameter structure BS (or the group B1 of personalized preference parameters B11, B12 and B13) and the group HA of public evaluation parameter structures HAI and HA2. For example, the personalized evaluation values KB1 and KB2 are generated by equations (6) and (7).

KB1=[(B11*G11)+(B12*G12)+(B13*G13)]/(B11+B12+B13)=[(3*4)+(3.5*3.5)+(5*3.8)]/(3+3.5+5)=3.76 (6)

KB2=[(B11*G21)+(B12*G22)+(B13*G23)]/(B11+B12+B13)=[(3*2)+(3.5*5)+(5*4)]/(2+5+4)=3.95 (7)

In step 2516, the processing unit 2104 performs a third operation CP3 on the first group EA of objects EA1, EA2 . . . EA8 an EA9 to generate a second group EB of objects EB1, EB2 . . . EB6 and EB7 with specific order. In an embodiment, the third operation CP3 is a sort operation, such as the bubble sort method, or quick sort method. That is to say, the processing unit 2104 reorders the first group EA of objects EA1, EA2 . . . EA8 and EA9 to generate the second group EB of objects EB1, EB2 . . . EB6 and EB7 with specific order, based on the user 2120's preference towards the first group EA of objects EA1, EA2 . . . EA8 and EA9.

In an embodiment, the third operation CP3 is an optimization operation. For example, the processing unit 2104 applies the optimization operation to choose the object with the highest user's preference. For example, the second group EB of objects EB1, EB2 . . . EB6 and EB7 contain all objects of the first group EA of objects EA1, EA2 . . . EA8 and EA9 or part objects thereof. In an embodiment, the processing unit 2104 performs the third operation CP3 to further generate the personalized information C1 containing the second group EB of objects EB1, EB2 . . . EB6 and EB7, and displays the personalized information C1 to the user 2120 through the interface unit 2102. Thus, the device 2100 matches the personalized information C1 with the user 2120, or matches the second group EB of objects EB1, EB2 . . . EB6 and EB7 with the user 2120.

In an embodiment according to FIGS. 7, 8(a), 8(b), 8(c) and 9, a device 2100 used for information matching includes an interface unit 2102 and a processing unit 2104 coupled to the interface unit 2102. The interface unit 2102 suggests a object classification PA related to a first group EA of objects EA1, EA2 . . . EA8 and EA9, and receives a personalized preference parameter structure RS and a first group of public evaluation parameter structure S1, S2 . . . SN. The processing unit 2104 obtains an operation result by operating each of the first group EA of objects based on the group R1 of personalized preference parameters and the first group of public evaluation parameter structure S1, S2 . . . SN.

In an embodiment, the processing unit 2104 controls the interface unit 2102. In an embodiment, the interface unit 2102 controls the processing unit 2104. In an embodiment, the interface unit 2102 suggests a plurality of object classifications P11, P12, P13 and P14 for users to choose one of them, wherein the object classification PA represents the selected object classification. In an embodiment, the interface unit 2102 further suggests an object attribute structure F1 for the user 2120 to input the group R1 of personalized preference parameters, wherein the object attribute structure F1 has the object classification PA and a specific attribute structure AS used to define the object classification PA.

In an embodiment, the processing unit 2104 operates the first group EA of objects EA1, EA2 . . . EA8 and EA9 one by one to generate a second group EB of objects EB1, EB2 . . . EB6 and EB7 with a specific order, wherein the first group EA of objects EA1, EA2 . . . EA8 and EA9 contain the second group EB of objects EB1, EB2 . . . EB6 and EB7. For example, the operation result contains the second group EB of objects EB1, EB2 . . . EB6 and EB7. In an embodiment, the processing unit 2104 transforms the personalized preference parameter structure RS into a personalized preference parameter structure BS based on the arithmetic operation CV1, and operates the first group EA of objects EA1, EA2 . . . EA8 and EA9 one by one to generate the second group EB of objects EB1, EB2 . . . EB6 and EB7.

In an embodiment according to FIGS. 7, 8(a), 8(b), 8(c) and 9, a method for information matching includes the following steps: suggesting an object classification PA related to a first group EA of objects EA1, EA2 . . . EA8 and EA9; receiving a personalized preference parameter structure RS and a first group of public evaluation parameter structures S1, S2 . . . SN corresponding to the first group EA of objects EA1, EA2 . . . EA8 and EA9; and operating the first group EA of objects EA1, EA2 . . . EA8 and EA9 one by one to obtain an operation result, based on the personalized preference parameter structure RS and the first group of public evaluation parameter structures S1, S2 . . . SN.

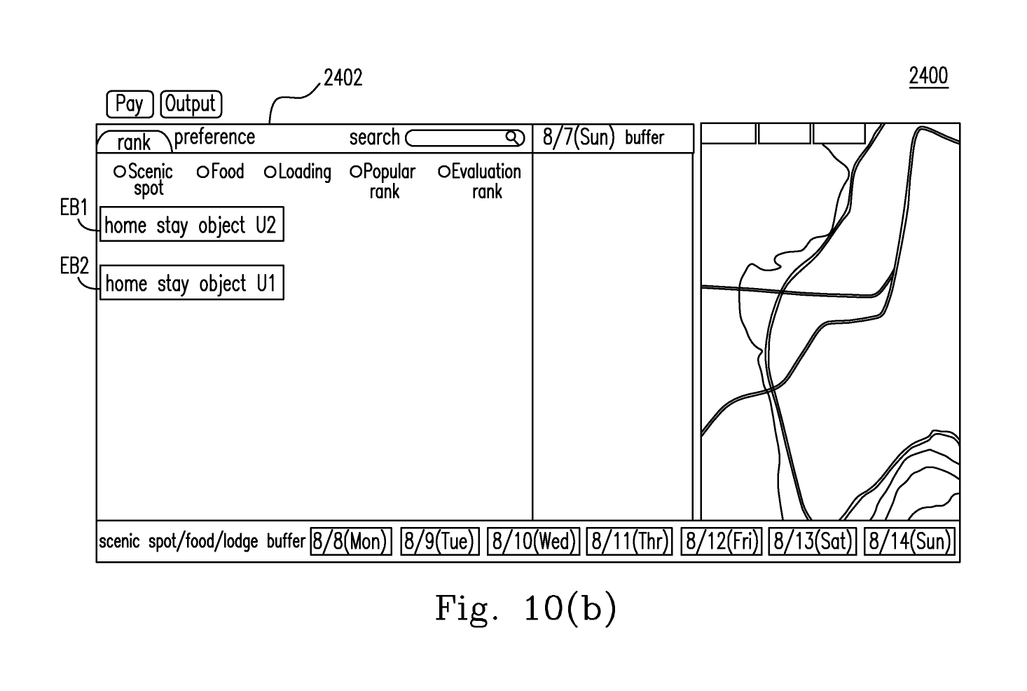

Please refer to FIG. 10(a), which illustrates a diagram of a first configuration of a travel system 2400 of the information matching device 2100 in accordance with an embodiment of the present disclosure. Please refer to FIG. 10(b), which illustrates a diagram of a second configuration of the travel system 2400 of the information matching device 2100 in accordance with an embodiment of the present disclosure. As shown in FIG. 10(a), the travel system 2400 has a preference 2402 button. The user 2120 clicks “preference 2402” to activate an interface unit 2102 to perform a preference setting. The interface unit 2102 suggests an object classification PA related to a first group EA of objects EA1, EA2 . . . EA8 and EA9, and receives a personalized preference parameter structure RS and a first group of public evaluation parameter structures S1, S2 . . . SN corresponding to the first group EA of objects EA1, EA2 . . . EA8 and EA9. Then, the processing unit 2104 operates the first group EA of objects EA1, EA2 . . . EA8 and EA9 one by one to obtain an operation result, based on the personalized preference parameter structure RS and the first group of public evaluation parameter structures S1, S2 . . . SN. In an embodiment, the operation is used to generate a second group EB of objects EB1, EB2 . . . EB6 and EB7 with specific order, wherein the first group EA of objects EA1, EA2 . . . EA8 and EA9 contain the second group EB of objects EB1, EB2 . . . EB6 and EB7.

For example, the user 2120 selects the home stay classification P13; next, the user 2120 sets the personalized preference parameter structure RS (please refer to FIG. 8(c)). Then, as shown in FIG. 10(b), the travel system 2400 generates the home stay object U1 and the home stay object U2, and the home stay object U2 displays in a higher priority than the home stay object U1, wherein the object EB1 represents the home stay object U2 and the object EB2 represents the home stay object U1.

In an embodiment, the processing unit 2104 operates the first group of EA of objects EA1, EA2 . . . EA8 and EA9 one by one to generate a first result, and selects an object which mostly matches the personalized preference parameter structure RS from the first group EA of objects EA1, EA2 . . . EA8 and EA9 as the operation result based on the first result, and displays the operation result to the user 2120 through the interface unit 2102. For example, the first result is a group KB of personalized evaluation values KB1, KB2 . . . KB8 and KB9 corresponding to the first group EA of objects EA1, EA2 . . . EA8 and EA9. For example, the travel system 2400 generates a home stay object U2 which mostly matches the user 2120, based on the personalized preference parameter structure RS set by the user 2120. If the user 2120 does not meet the operation result, he may re-click “preference 2402” to reset the personalized preference parameter structure RS.

In an embodiment, the first group EA may include only object EA1, and the information matching system 140a based on the personalized preference parameter structure RS input by the user 2120 to determine whether to recommend the object EA1 to the user. If the object EA1 meets the requirement of the user described by the personalized preference parameter structure RS, the information matching system 140a recommends the object EA1 to the user; in the contrast, if the object EA1 dose not meet the requirement of the user described by the personalized preference parameter structure RS, the information matching system 140a recommend no object to the user.

In an embodiment, an matching information method is applied to the information matching system 2010, wherein the matching information method includes steps of receiving a first specific parameter (such as a personalized preference parameter structure RS) corresponding to a first group of travel objects (such as the first group EA of objects EA1, EA2 . . . EA8 and EA9), receiving a first public parameter (such as the first group of public evaluation parameter structures S1, S2 . . . SN), and performing a first calculating operation (such as a first operation CP1) to generate a second group of travel objects (such as a second group EB of objects EB1, EB2 . . . EB6 and EB7) based on the first specific parameter and the first public parameter. The matching information method may further include a step of arranging respective ones of the second group of travel objects in a specific order by performing the first calculating operation, wherein the ones of the second group of travel objects are at least partially overlapped with those of the first group of travel objects.

In another embodiment, the first public parameter is obtained by pre-evaluating the first group of travel objects, the first specific parameter is a first personalized preference parameter, and the first personalized preference parameter and the first public parameter are transformed into a first personalized preference parameter structure and a first public parameter structure. The first calculating operation further includes a step of transforming the first personalized preference parameter structure into a second personalized preference parameter structure based on an arithmetic operation (such as an arithmetic operation CV1).

In an embodiment, the matching information method may further include steps of performing a second calculating operation (such as a second operation CP2) to generate a group of personalized evaluation values (such as the group KB of personalized evaluation values KB1, KB2 . . . KB8 and KB9) corresponding to the first group of travel objects based on the second personalized preference parameter structure and the first public parameter structure; and performing a third calculating operation on the first group of travel objects to cause respective objects of the second group of travel objects to be arranged in a specific order based on the group of personalized evaluation values. The second calculating operation is one selected from the group consisting of a weighted operation, a relational analysis operation and a combination thereof, and the third calculating operation includes a sort operation and is operated based on a public information (such as the public information 2D1).

The matching information method may further include a step of generating a third group of travel objects (such as a third group EC of objects EC1, EC2 . . . EC8 and EC9) based on the third calculating operation, generating a public evaluation value (such as the plurality of public evaluation values T1, T2 . . . TN) corresponding to the third group of travel objects based on a second public evaluation parameter structure which is obtained by pre-evaluating the third group of travel objects, and sorting the third group of travel objects to generate the first group of travel objects based on the public evaluation value.

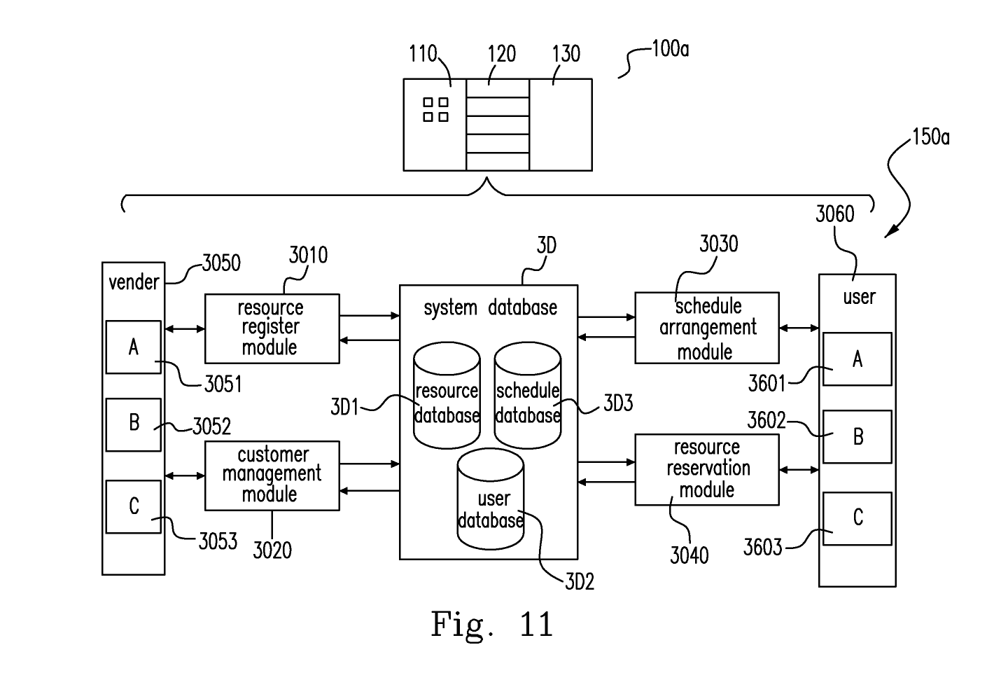

Please refer to FIG. 11, which illustrates a schedule arrangement system 100a in accordance with another embodiment of the present disclosure. The schedule arrangement system 100a includes a schedule arrangement and resource reservation integration system 150a used for planning the schedule 120 for users. When users finish planning, the schedule arrangement and resource reservation integration system 150a performs the resource reservation needed by the schedule 120 based on the schedule 120. The schedule arrangement and resource reservation integration system 150a includes a resource register module 3010, a customer management module 3020, a schedule arrangement module 3030, a resource reservation module 3040 and a system database 3D, wherein the system database 3D includes but is not limited to the resource database 3D1, user database 3D2 and schedule database 3D3.

The schedule arrangement module 3030 is used for a user 3060 (user A 3601, user B 3602 and user C 3603) to arrange a schedule. The schedule arrangement module 3030 may include a schedule arrangement module used for a user to arrange the schedule list; a transportation arrangement module used to arrange the moving itinerary and transportation vehicles between places; a budget arrangement module used to arrange the schedule budget for users; a resource arrangement interface used to arrange a variety of resources needed by users; or a backup arrangement interface used to arrange another backup for users. The schedule arrangement module 3030 may arrange a travel schedule, a business activity schedule or a manufacturing process schedule.

The resource reservation module 3040 is used for a user to perform single resource reservation, a plurality of resource reservation, all resource reservation, single resource cancel, a plurality of resource cancel or all resource cancel needed by the schedule, wherein the single resource reservation, a plurality of resource reservation, all resource reservation, single resource cancel, a plurality of resource cancel or all resource cancel are proceeded when the user 3060 uses the schedule arrangement module 3030 or finishes the schedule arrangement. The resource reservation module 3040 may reserve accommodation rooms, restaurant seats, plane tickets or movies, etc.

The resource register module 3010 is coupled to the schedule arrangement module 3030, and the resource register module 3010 is used to enable the resource provide vendor 3050 or the system manager to register the resource to the system, enabling the user to perform schedule arrangement and resource reservation. The customer manage module 3020 is coupled to the resource reservation module 3040, and the customer manage module 3020 is used to enable the resource provide vendors 3050 or the system manager to obtain the notification that the user reserves resource, and the customer manage module 3020 may further manage customers. The system database 3D is coupled to the schedule arrangement module 3030 which is used to store a variety of related information of resource, schedule and users.

The resource register module 3010 and the customer management module 3020 are used for vendors (such as vendor A 3501, vendor B 3502 and vendor C 3503) to provide the information message, monitor whether there is a change in the schedule which is reserved resource and give warning (if there is a change), and manage customers who reserve the resource.

The schedule arrangement and resource reservation integration system 150a has three embodiments as follows:

Embodiment 1: After a user finishes the schedule arrange, the user may reserve or trade all of the resource needed in the schedule or part of the resource needed in the schedule, such as the accommodation room and the restaurant seat.

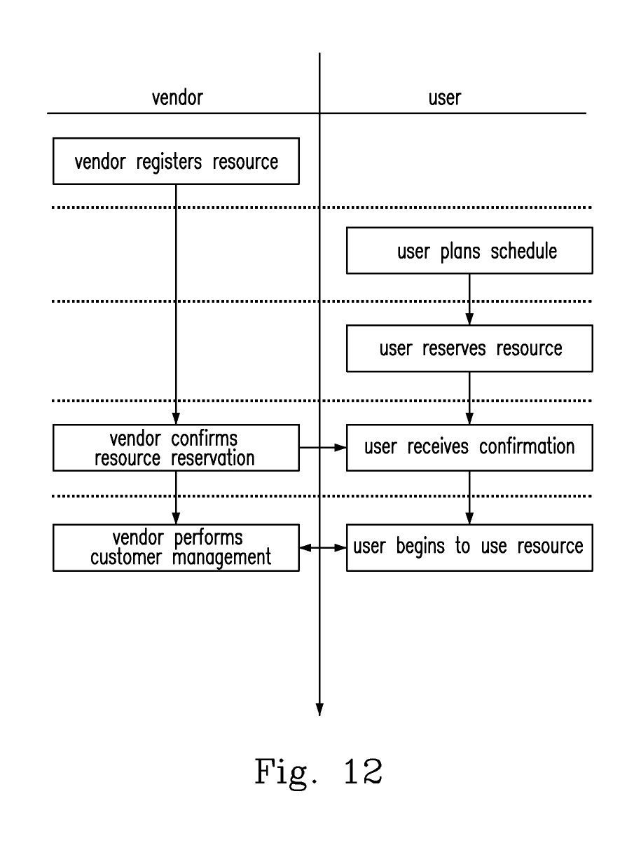

Please refer to FIGS. 11 and 12, wherein FIG. 11 illustrates a diagram of the schedule arrangement and resource reservation integration system, and FIG. 12 illustrates a flow chart of the schedule arrangement and resource reservation integration system in accordance with an embodiment of the present disclosure. The implementation steps of the present embodiment are as follows:

Step 1: Vendor 3050 registers the resource information.

(1) Firstly, vendor 3050 enters the resource register module 3010 of the present disclosure.

(2) Vendor 3050 operates the resource register module 3010 and inputs the provided resource into the resource database 3D1 of the system database 3D, such as the accommodation room, the restaurant seat, the movie seats, the plane tickets, etc. The display interface will show the vendor 3050 whether the resource register is succeed or not.

Step 2: User arranges the schedule.

(1) Users enter the schedule arrange module 3030.

(2) The schedule arrangement module 3030 reads a variety of resources provided by the vendor 3050 from the resource database 3D1 and the schedule database 3D3, such as the accommodation room, the restaurant seat, the movie seats, the plane tickets, etc. The schedule arrangement module 3030 displays the resources provided by the vendor 3050 on the arrangement interface.

(3) Users may choose interested scenic spots or interested resource to perform schedule arrangement, based on the information displayed on the schedule arrangement interface. In the present embodiment, the user chooses “Taipei 101” as the interested scenic spot and “Grand Hyatt Taipei ” as the interested resource. When a user 3060 selects one of the resources in the resource database 3D1 from the schedule arrangement interface, the resource reservation module is automatically actuated and further reads the related information from the resource database 3D1.

(4) The schedule arrangement module 3030 writes the schedule arrangement information finished by the user into the schedule database 3D3 of the system database 3D.

Step 3: User reserves resource.

(5) After the user 3060 confirms the reservation of “Grand Hyatt Taipei', the resource reservation module 3040 writes the resource reservation information into the resource database 3D1, schedule database 3D3 and user database 3D2 of the system database, and after the user 3060 performs the necessary trade about the reservation, “Grand Hyatt Taipei” is notified.

(6) If the user wants to reserve all of the resource provided by “Grand Hyatt Taipei”, “Let's tasty steak” and “Taipei city zoo” on the schedule arrange interface, such as the room, seat, ticket and so on, the resource reservation module 3040 is used to write all of the resource reservation information to the resource database 3D1, schedule database 3D3 and user database 3D2 of the system database, and sums the required outlay. After the user 3060 pays the outlay, the resource reservation module 3040 notifies “Grand Hyatt Taipei”, “Let's tasty steak” and “Taipei city zoo”.

Step 4: Vendor confirms the resource reservation and user receives the confirmation.

(7) “Grand Hyatt Taipei” confirms that the resource reservation by the user 3060 is succeeded, and notifies the user 3060 through the customer management module 3020, and “Grand Hyatt Taipei” may get the related information from the customer management module 3020.

(8) User 3060 receives a confirmation of the room reservation of “Grand Hyatt Taipe”.

Step 5: User uses resource and vendor performs customer management.

(9) The user 3060 travels according to the schedule and lodges in the “Grand Hyatt Taipei”.

(10) “Grand Hyatt Taipei” reads the customer information through the customer management module 3020 to perform service and management, and writes the relevant record to the user database 3D2 of the system database 3D.

Embodiment 2: The user has reserved the resource and the reserved resource may be adjusted based on the change of the schedule.

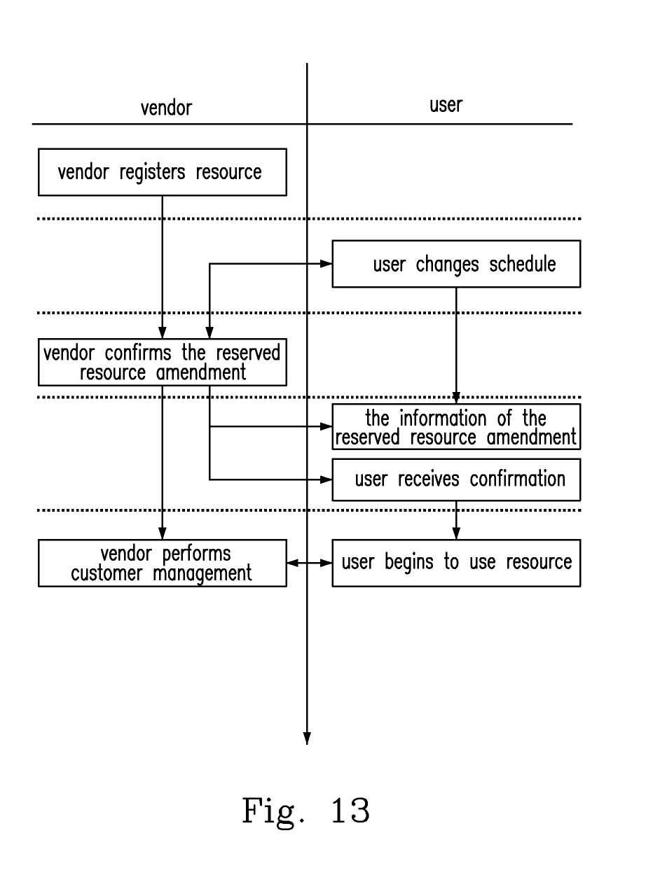

Please refer to FIGS. 11 and 13, wherein FIG. 11 illustrates a diagram of the schedule arrangement and resource reservation integration system, and FIG. 13 illustrates a flow chart of the schedule arrangement and resource reservation integration system in accordance with another embodiment. The implement steps of the present embodiment are as follows:

Step 1: Vendor 3050 registers the resource information.

(1) Firstly, vendor 3050 enters the resource register module 3010.

(2) Vendor 3050 operates the resource register module 3010 and inputs the provided resource into the resource database 3D1 of the system database 3D, such as the accommodation room, the restaurant seat, the movie seats, the plane tickets, etc. The display interface will show the vendor 3050 whether the resource register is succeeded or not.

Step 2: The user 3060 change the schedule.

(3) The user 3060 enters the schedule arrangement module 3030.

(4) The schedule arrangement module 3030 reads the pre-arranged schedule information by users from the schedule database 3D3, such as the schedule duration, schedule target and the visited scenic spots, accommodation and restaurant. In the present embodiment, the schedule may be “taipei 3 days trip”. The schedule arrangement module 3030 may read the resource provided by vendors from the resource database 3D1, such as the accommodation room, the restaurant seat, etc., and the resource provided by the vendors will be displayed on the schedule interface.

(5) User 3060 may choose interested scenic spots or interested resource to perform schedule arrangement, based on the information displayed on the schedule arrangement interface. In the present embodiment, the user adds “Beitou spring museum” as the interested scenic spot and “Beitou villa 32” as the interested resource, wherein the schedule arrangement module 3030 arranges at least one itinerary path for the Beitou spring museum and the Beitou villa 32, and arranges a traffic way for the itinerary path.

(6) User 3060 replaces the “Taipei 101” with “Beitou spring museum” and replaces “Grand Hyatt Taipei” with “Beitou villa 32”.

(7) The resource reservation module 3040 detects that the change has affected the room reservation of “Grand Hyatt Taipei”. The resource reservation module 3040 shows a “cancel warning” to notify the user, and confirms with the user whether the room reservation of “Grand Hyatt Taipei” has been cancelled.

(8) User 3060 confirms cancelling the room reservation of “Grand Hyatt Taipei” and performs the relevant procedures of cancelling the room reservation. The resource reservation module 3040 sends the change information to “Grand Hyatt Taipei”.

(9) The schedule arrangement module 3030 writes the changed schedule information into the schedule database 3D3 of the system database D.

Step 3: Vendor confirms that the reserved resource has been changed.

(10) “Grand Hyatt Taipei” receives the reserved resource change information from the resource reservation module 3040 and begins to perform the deposit-returning procedure and successfully changes the information. “Grand Hyatt Taipei” returns information to the resource reservation module 3040 and the customer management system 3020.

Step 4: The reserved resource is amended, and the user receives confirmation.

(11) The resource reservation module 3040 receives the changed confirmation message from “Grand Hyatt Taipei” and writes the changed reserved resource information into the resource database 3D1, user database 3D2 and schedule database 3D3 of the system database 3D.

(12) The user 3060 receives the reserved resource change confirmation notified by the customer management system 3020.

Step 5: User uses the resource and vendor performs the customer management.

(13) The user 3060 travels according to the schedule and lodges in the “Beitou villa 32”.

(14) “Beitou villa 32” reads the customer information through the customer management module 3020 to perform service and management, and writes the relevant record to the user database 3D2 of the system database 3D.

### Embodiment 3: The user may reserve resource and import the reserved resource into the schedule.

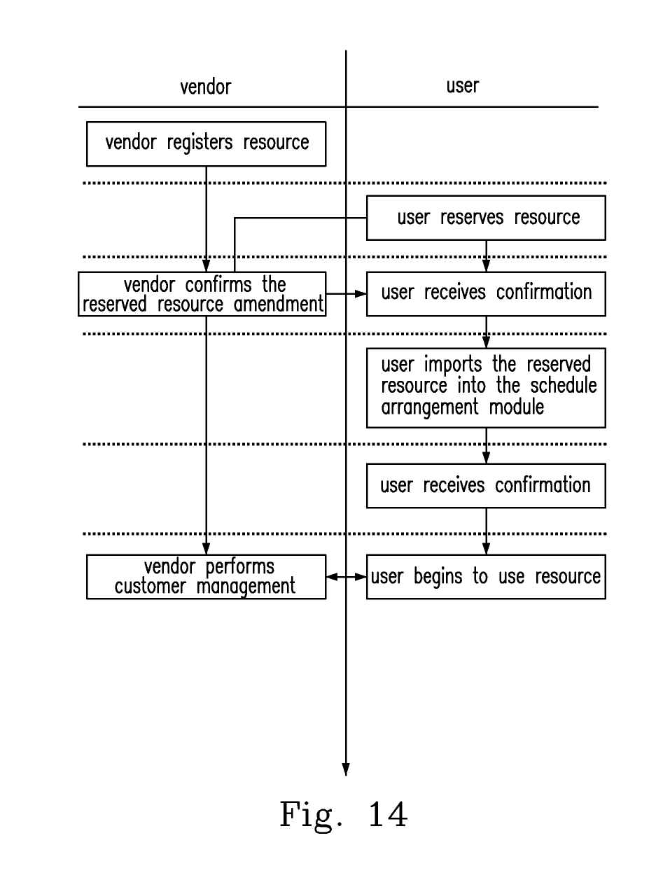

Please refer to FIGS. 11 and 14, wherein FIG. 11 illustrates a diagram of the schedule arrangement and resource reservation integration system, and FIG. 14 illustrates a flow chart of the schedule arrangement and resource reservation integration system in accordance with another embodiment. The implement steps of the present embodiment are as follows:

Step 1: Vendor 3050 registers resource information.

(1) Firstly, vendor 3050 enters the resource register module 3010 of the present disclosure.

(2) Vendor 3050 operates the resource register module 3010 and inputs the provided resource into the resource database 3D1 of the system database 3D, such as the accommodation room, the restaurant seat, the movie seats, the plane tickets, etc. The display interface will show the vendor 3050 whether the resource register is succeeded or not.

Step 2: User reserves resource.

(3) The user 3060 enters the resource reservation module 3040.

(4) The resource reservation module 3040 reads a variety of resources provided from the resource database 3D1 of the system database 3D, such as the accommodation room, the restaurant seat, the movie seats, the plane tickets, etc, and the read result will be displayed on the User 3060 display interface.

(5) The user 3050 chooses the desired resource based on the personal needs and preference, confirms the reservation and finishes the necessary trade. In the present embodiment, the user reserves “Regent Taipei”.

(6) After the user 3060 confirms reservation of “Regent Taipei”, the resource reservation module 3040 writes the resource reservation information to the resource database D31, schedule database 3D3 and user database 3D2 of the system database 3D. After the user 3060 performs the necessary reservation trade, the resource reservation module 3040 notifies “Regent Taipei”.

Step 3: The vendor confirms the resource reservation and the user receives the confirmation.

(7) “Regent Taipei” confirms that the user 3060 successfully reserves the resource, notifies the user 3060 through the customer management module 3020, and may get the relevant customer information from the customer management module 3020.

(8) The user 3060 receives the confirmation of the room confirmation of “Regent Taipei”.

Step 4: The user imports the reserved resource in the schedule arrangement module 3030.

(9) The user 3060 enters the schedule arrangement module 3030.

(10) The schedule arrangement module 3030 reads the schedule information from the schedule database 3D3, such as the schedule duration, schedule target, etc., and the schedule information will be displayed on the arrangement interface.

(11) The user 3060 chooses the reserved “Regent Taipei” room which is to be imported in the schedule arrangement module 3030.

(12) The schedule arrangement module 3030 reads the room reservation information of “Regent Taipei” from the resource database 3D1 and user information database 3D2 of the system database 3D, and displays the read result on the schedule arrangement interface.

(13) The schedule arrangement module 3030 writes the room reservation information read from the resource database 3D1 and user information database 3D2 into the schedule database 3D3.

(14) The user may choose interested scenic spots or interested resource to perform schedule arrangement, based on the information displayed on the schedule arrangement interface. In the present embodiment, the user chooses the “spot light taipei” near “Regent Taipei”.

(15) The schedule arrangement module 3030 writes the finished schedule arrangement information into the schedule database 3D3 of the system information 3D.

Step 5: The user uses the resource and the vendor performs the customer management.

(16) The user 3060 travels according to schedule and lodges in the “Regent Taipei”.

(17) “Regent Taipei” reads the customer information from the customer management module 3020 to perform service and management, and writes the relevant record to the user database 3D2 of the system database 3D.

In an embodiment, a reserving method is applied to the schedule arrangement and resource reservation integration system 150a, wherein the reserving method (such as embodiment 1) includes steps of arranging a schedule (such as embodiment 1, step 2), obtaining a resource corresponding to the schedule, and performing a reservation for the resource while arranging the schedule or after finishing the schedule (such as embodiment 1, step 3), wherein the reservation is one selected from the group consisting of a single resource reservation, a partial resource reservation and an all resource reservation. The matching information optionally includes a step of performing a cancellation for the reservation (such as embodiment 2, step 2), wherein the cancellation is one selected from the group consisting of a single resource cancellation, a partial resource cancellation and an all resource cancellation.

In an embodiment, the reserving method further includes steps of performing an amendment to the schedule, and adjusting the resource based on the amendment (such as embodiment 2). In another embodiment, the method further includes steps of receiving a user's determination, and arranging the scheduling order according to the user's determination, and the schedule has a scheduling order. In still another embodiment, the reserving method further includes steps of arranging at least one itinerary path for the respective plural locations, and optionally includes a step of arranging a traffic way for the itinerary path. The schedule includes plural locations. In still another embodiment, the reserving method further includes a step of arranging a budget for the schedule. In still another embodiment, the reserving method further includes a step of arranging a backup schedule.

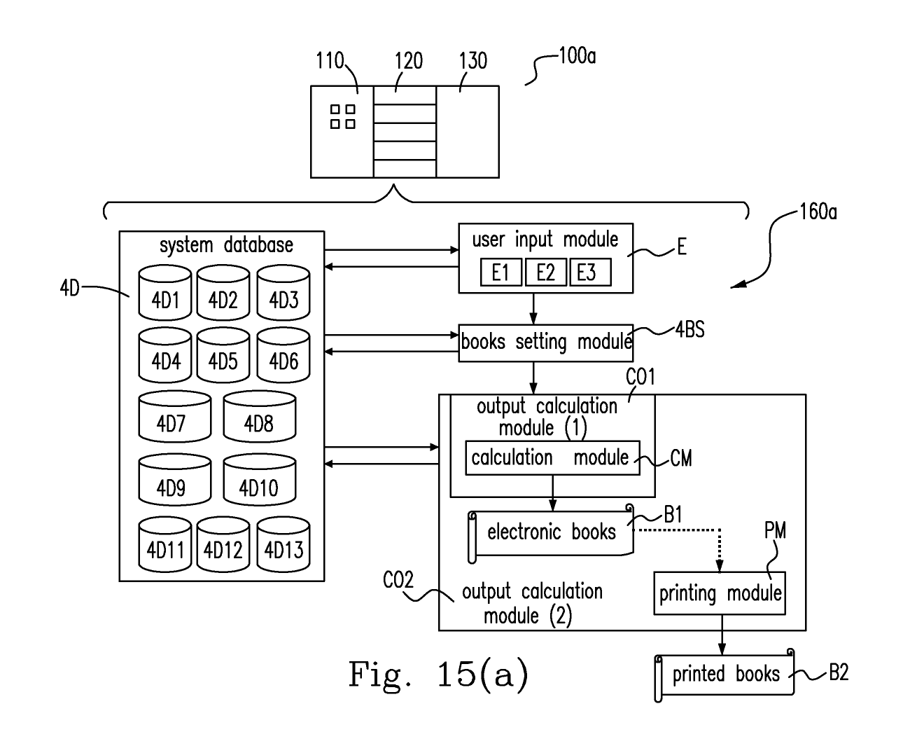

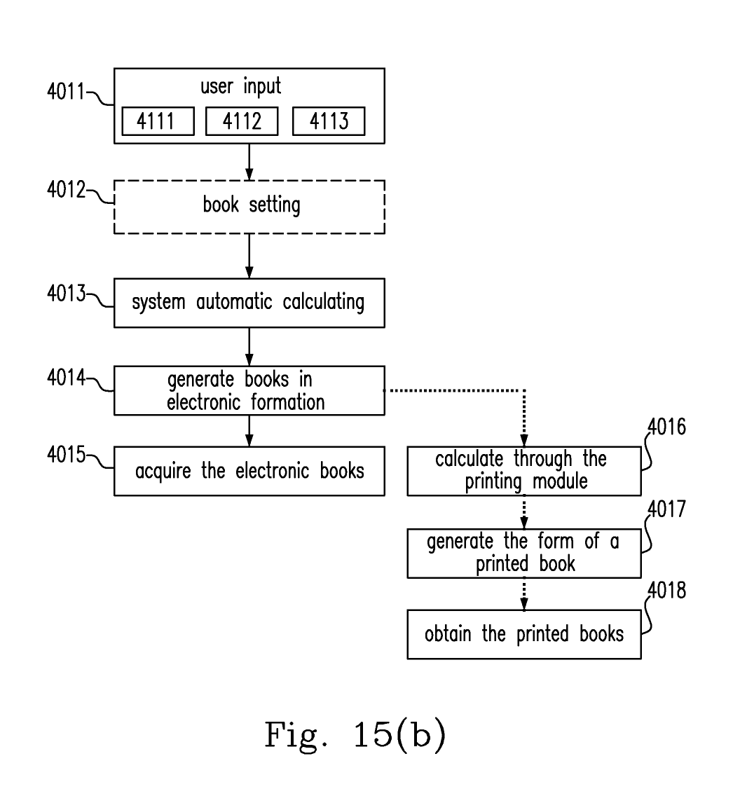

Please refer to FIG. 15(a), which illustrates a schedule arrangement system 100a in accordance with another embodiment of the present disclosure. The schedule arrangement system 100a includes a personalized travel information automatic output system 160a. FIG. 15(a) shows a block diagram in accordance with the first, second and third embodiments of the personalized travel information automatic output system 160a. The personalized travel information automatic output system 160a includes a system database 4D1. The system database 4D1 includes a tour location database 4D11, a restaurant database 4D12, a lodge database 4D13, a tour database 4D14, a tour companion database 4D15, a traffic route database 4D16, an output media setting database 4D17, an output subject color database 4D18, an output cover and bottom pages database 4D19, an output format editing database 4D20, a photo database 4D21, a travel database 4D22 and a film database 4D23.

The right block illustrates a user input module E, a book setting module 4BS, an output calculation module (1)CO1, and an output calculation module (2) CO2, wherein the user input module E includes a travel schedule planning module E1, a travel tour record module E2 and a travel information selection module E3. The output calculation module (1)CO1 includes a calculation module CM. The output calculation module (1)CO1 performs calculation based on at least a travel schedule, travel record group or travel information group and the book setting information, and finally generates an electronic book B1. The output calculation module (2)CO2 includes the calculation module CM, the electronic book B1 and a printing module PM. The output calculation module (2) performs calculation based on at least a travel schedule, travel record group or travel information group and the book setting information, and finally generates a printed book B2.

Refer to FIG. 15(b), which illustrates a flow diagram showing a personalized travel information automatic output system according to the first to the third embodiments of the present invention. Firstly, a user performs the operation of user input via a user input module E (Step 4011). The operation may include implementing travel tour planning (Step 4111), setting travel record group (Step 4112) which includes selecting from a group composed one of a photo editing module, a travel editing module and a video editing module and uploading one of photos, travels, food diaries, audio, video, films, notes, clicking recording and any combination thereof and selecting travel information (Step 4113) such as information related to travel including locations, restaurants, lodges, activities, shows, package tours, introductions, opening schedules, traffic routes, prices, index of recommendation and suggested travelling seasons provided by a firm, a company or a person.

Afterwards, the user implements an operation of book setting via a book setting module 4BS (Step 4012). The operation includes setting a formation of the book, an editing format of the book, color of the book title or cover as well as bottom pages of the book and even the category contents, number of pages, size, subjects, font and etc., and determining an output result which can be electronic book formation or printed book formation.

Notably, the operation of book setting (Step 4012) is not necessary, i.e., the user may skip this step and jump into the next step, which is system automatic calculating (Step 4013), based on the user's requirements

After the completion of the operation of book setting (Step 4012), if the user chooses to output an electronic book, the calculation module CM in the output calculation module (1)CO1 performs calculation (Step 4013) based on contents of the travel schedule inputted by the user (Step 4111), travel record group (Step 4112) and the travel information group (4113) and the book setting information (Step 4012), and generates books in the electronic formation B1 (Step 4014). The user may acquire the electronic books following the operations of searching, download and sharing (Step 4015).

If the user chooses to output a printed book, the calculation module CM in the output calculation module (2) performs calculation (Step 4013) based on contents of the travel schedule inputted by the user (Step 4111), travel record group (Step 4112) and the travel information group (4113) and the book setting information (Step 4012), generates books in electronic formation B1 (Step 4014), and eventually generates a printed book B2 (Step 4017) via the calculation of the printing module PM. The user may acquire the printed books following the operations of printing, mailing, fax and etc. (Step 4018)

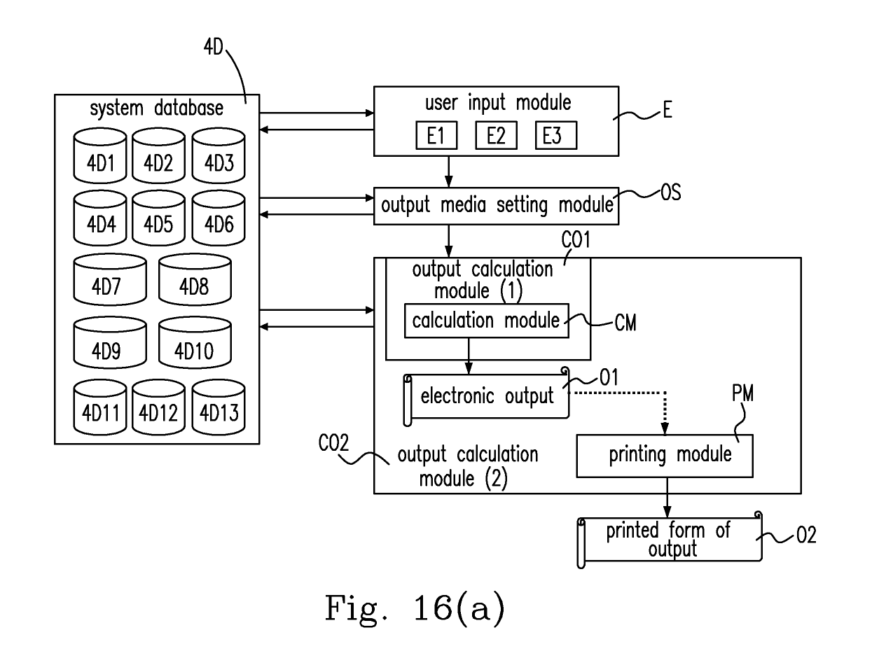

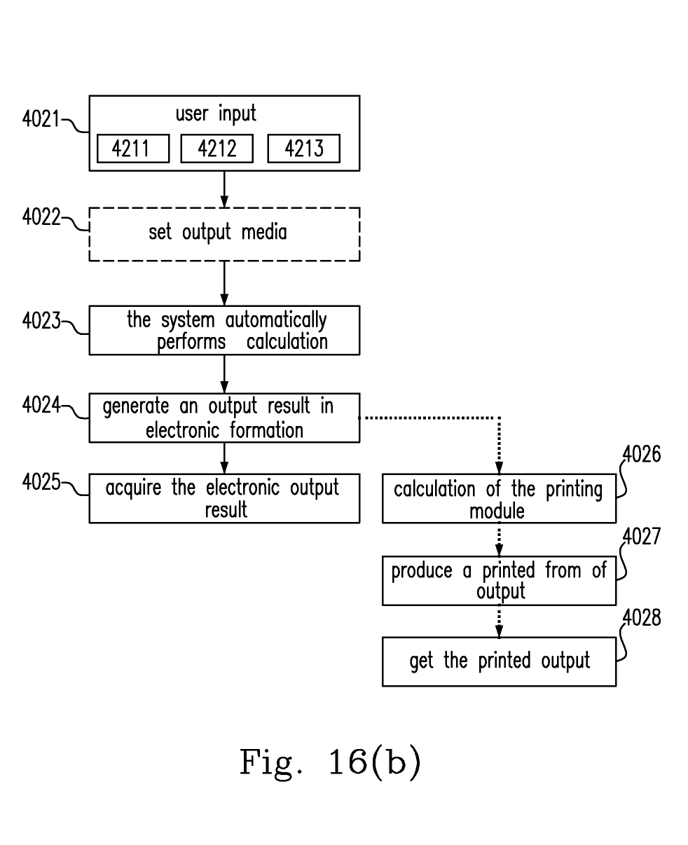

Refer to FIG. 16(a), which illustrates a block diagram showing a personalized travel information automatic output system according to the fourth embodiment of the present invention, including a system database 4D1 having but not limited to a tour location database 4D11, restaurant database 4D12, lodge database 4D13, tour database 4D14, tour companion database 4D15, traffic route database 4D16, output media setting database 4D17, output subject color database 4D18, output cover and bottom pages database 4D19, output format editing database 4D20, photo database 4D21, travel database 4D22 and film database 4D23.

In the right of FIG. 16(a), there are system modules including a user input module with a travel schedule planning module E1, a travel record module E2 and a travel information selection module E3, an output media setting module OS, an output calculation module (1) CO1 comprising a calculation module CM for performing calculation based on at least a travel schedule, travel record group or travel information group and the output media setting information, and generating an electronic output result O1 and an output calculation module (2) CO2 comprising a calculation module CM for performing calculation based on at least a travel schedule, travel record group or travel information group and the book setting information, and generating a printed output result O2.

Refer to FIG. 16(b), which illustrates a flow diagram showing a personalized travel information automatic output system according to the fourth embodiment of the present invention. Firstly, a user performs the operation of user input via a user input module E (Step 4021). The operation may include implementing travel tour planning (Step 4211), setting travel record group (Step 4212) which includes selecting from a group composed one of a photo editing module, a travel editing module and a video editing module and uploading one of photos, travels, food diaries, audio, video, films, notes, clicking recording and any combination thereof and selecting travel information (Step 4213) such as information related to travel including locations, restaurants, lodges, activities, shows, package tours, introductions, opening schedules, traffic routes, prices, index of recommendation and suggested travelling seasons provided by a firm, a company or a person.

Afterwards, the user implements an operation of setting output media via an output media setting module OS (Step 4022). The operation includes setting contents of the output, color of the subject letters, format, size, subjects, font and etc., and determining a non-interactive output media carrying the contents of the output to form a non-interactive output result. The non-interactive output media is a group consisted of an electronic output result and a printed output media, wherein the non-interactive electronic output media is one selected from a group consisted of emails, electronic books, electronic documents, electronic pictures, electronic films and electronic cartoons, and the printed output media is one selected from a group consisted of documents, books, cloths, cups and decorations.

Notably, the operation of media setting (Step 4022) is not necessary, i.e., the user may skip this step and jump into the next step, which is system automatic calculating (Step 4023), based on the user's own requirements

After the completion of the operation of output media setting (Step 4022), if the user chooses to output an electronic book, the calculation module CM in the output calculation module (1)CO1 performs calculation (Step 4023) based on contents of the travel schedule inputted by the user (Step 4211), travel record group (Step 4212) and the travel information group (4213) and the output media setting information (Step 4022), and generates an output result in the electronic formation O1 (Step 4024). The user may acquire the electronic output result O1 following the operations of searching, download and sharing (Step 4025).

If the user chooses to output a printed output result, the calculation module CM in the output calculation module (2) performs calculation (Step 4023) based on contents of the travel schedule inputted by the user (Step 4211), travel record group (Step 4212) and the travel information group (4213) and the output media setting information (Step 4022), generates an output result in electronic formation O1 (Step 4024), and eventually generates a printed output result O2 (Step 4027) via the calculation of the printing module PM (Step 4026). The user may acquire the printed output result following the operations of printing, mailing, fax and etc. (Step 4028)

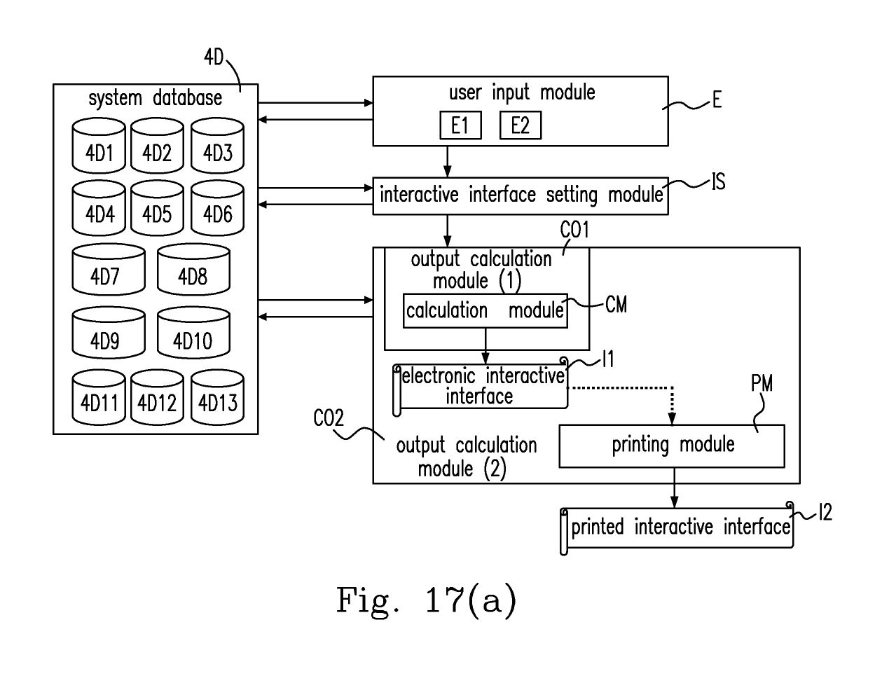

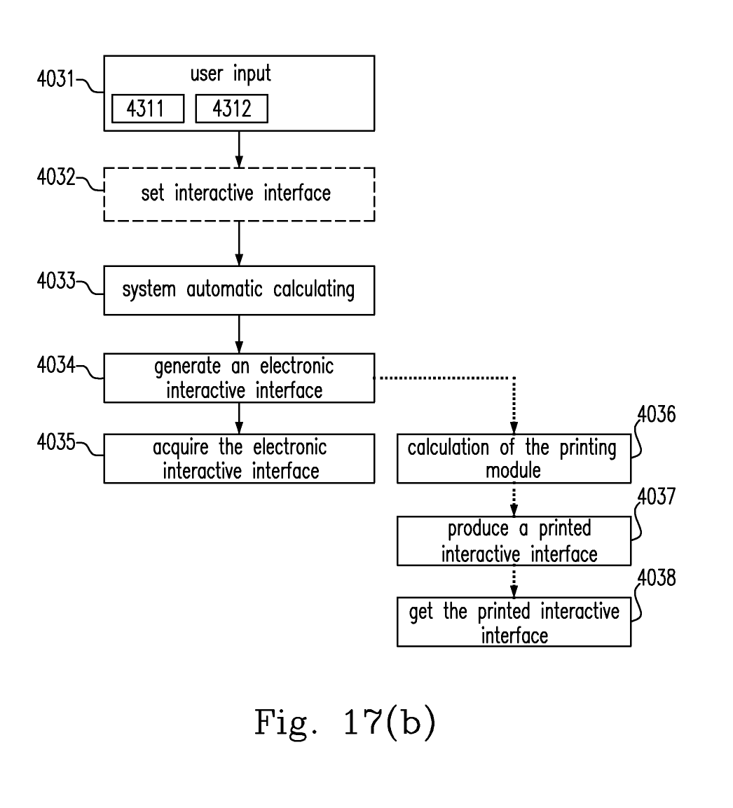

Refer to FIG. 17(a), which illustrates a block diagram showing a personalized travel information automatic output system according to the fifth embodiment of the present invention, including a system database 4D1 having but not limited to a tour location database 4D11, restaurant database 4D12, lodge database 4D13, tour database 4D14, tour companion database 4D15, traffic route database 4D16, output media setting database 4D17, output subject color database 4D18, output cover and bottom pages database 4D19, output format editing database 4D20, photo database 4D21, travel database 4D22 and film database 4D23.

In the right of FIG. 17(a), there are system modules including a user input module with a travel schedule planning module E1, a travel record module E2 and a travel information selection module E3, an interactive interface setting module IS, an output calculation module (1) CO1 comprising a calculation module CM for performing calculation based on at least a travel schedule, travel record group or travel information group and the output media setting information, and generating an electronic interactive interface I1 and an output calculation module (2) CO2 comprising a calculation module CM for performing calculation based on at least a travel schedule, travel record group or travel information group and the book setting information, and generating a printed interactive interface I2.

Refer to FIG. 17(b), which illustrates a flow diagram showing a personalized travel information automatic output system according to the fifth embodiment of the present invention. Firstly, a user performs the operation of user input via a user input module E (Step 4031). The operation may include implementing travel tour planning (Step 4311), setting travel record group (Step 4312) which includes selecting from a group composed one of a photo editing module, a travel editing module and a video editing module and uploading one of photos, travels, food diaries, audio, video, films, notes, clicking recording and any combination thereof.

Afterwards, the user implements an operation of setting output media via the interactive media setting module IS (Step 4032). The operation includes setting contents of the output, color of the subject letters, format, size, subjects, font and etc., and determining an interactive media carrying comprising a schedule and enabling a browser perform an interaction with the schedule. The interaction is one selected from a group consisted of a selection, a dragging, an editing, a deleting and an adding.

Notably, the operation of interactive media setting (Step 4032) is not necessary, i.e., the user may skip this step and jump into the next step, which is system automatic calculating (Step 4033), based on the user's own requirements

After the completion of the operation of output media setting (Step 4022), if the user chooses to output an electronic book, the calculation module CM in the output calculation module (1)CO1 performs calculation (Step 4033) based on contents of the travel schedule inputted by the user (Step 4311), travel record group (Step 4312) and the travel information group (4313) and the interactive media setting information (Step 4032), and generates an electronic interactive interface I1 (Step 4034). The user may acquire the electronic interactive interface I1 following the operations of searching, download and sharing (Step 4035).

If the user chooses to output a printed output result, the calculation module CM in the output calculation module (2) performs calculation (Step 4033) based on contents of the travel schedule inputted by the user (Step 4311), travel record group (Step 4312) and the travel information group (4313) and the interactive interface setting information (Step 4032), generates an electronic interactive interface I1 (Step 4034), and eventually generates a printed interactive interface I1 (Step 4037) via the calculation of the printing module PM (Step 4036). The user may acquire the printed interactive interface following the operations of printing, mailing, fax and etc. (Step 4038)

The present invention will be further introduced with the following embodiments set forth below.

### Embodiment 1: Travel Schedule Being Automatically Outputted as Electronic Books

Refer to FIGS. 15(a) and (b), a user accesses the travel tour planning module E1 in the user input module E (Step 4111). The travel tour planning module E1 reads the tour location database 4D11, the restaurant database 4D12, the lodge database 4D13, the tour database 4D14, the tour companion database 4D15 and the traffic route database 4D16 of the system database 4D, and the information relevant to tour location, restaurant, lodge, traffic route and etc. is displaced on the user interface for the user to perform a brand new travel tour planning or resume an unfinished planning. When the user has completed the travel tour planning, the travel tour planning module E1 writes the planned travel information and elements such as the location the restaurant, the lodge, the traffic route and etc. arranged in the tour planning into databases corresponding to locations, restaurants, lodge, traffic routes and etc. of the travel schedule database.

When the user gives an instruction of outputting the travel tour schedule information to the travel tour planning module E1, the travel tour planning module E1 transmits the abovementioned schedule planning parameters to the book setting module 4BS. Meanwhile, the display page automatically enters the book setting module 4BS, and guides the user to perform the book setting operation (Step 4012).

In the present embodiment, the user implements an operation of book setting via a book setting module 4BS (Step 4012). The book setting module 4BS includes cover as well as bottom pages of the book, formations of the book, editing format of the book, color of the book title or and even the category contents, number of pages, size, subjects, font and etc. available for the user. After the user has determined and confirmed the output contents, the book setting module 4BS writes the setting parameters determined by the user into the corresponding sub-databases of the system database 4D (such as output subject color database 4D18, output cover and bottom pages database 4D19, output format editing database 4D20 and etc.), and the system enables the output calculation module CO1, CO2 to perform calculations (Step 4013).

Notably, the user may skip the step set up on the preceding paragraph and instruct the system to jump into the next step, which is system automatic calculating (Step 4013), based on the user's requirements

After the completion of the operation of book setting (Step 4012), according to the present embodiment, if the user chooses to output an electronic book, the calculation module CM in the output calculation module (1)CO1 performs calculation (Step 4013) based on contents of the travel schedule inputted by the user (Step 4111) and the book setting information (Step 4012), writes the result into the system database 4D, generates books in the electronic formation B1 (Step 4014), and informs the user the prices to by paid for obtaining the result via watching, download or sharing.

Of the price to be paid is zero, the user may acquire the electronic books following the operations of searching, download and sharing (Step 4015), and view the electronic books or download to the user's computer/mobile device, or share the electronic books B1 with others at other websites or blogs.

If the price to be paid is not zero, the user enters the payment process, and then acquire the electronic books following the operations of searching, download and sharing (Step 4015), and view the electronic books or download to the user's computer/mobile device, or share the electronic books B1 with others at other websites or blogs.

### Embodiment 2: Travel Record Being Automatically Outputted into Printed Books

Refer to FIGS. 15(a) and (b), a user accesses the travel tour planning module E2 in the user input module E to perform the operation of setting the travel record group (Step 4112).

The travel tour planning module E2 reads the tour location database 4D11, the restaurant database 4D12, the lodge database 4D13, the tour database 4D14, the tour companion database 4D15 and the traffic route database 4D16 of the system database 4D to collect completed travel information such as departing time, tour location, restaurant, lodge, traffic route and etc. Then, the user uploads photos, travel, food diary, video, audio, notes, clicking record or the combination thereof via the travel record module E2, and performs matching based on the time and location of the files and the schedule information.

For instance, the user uploads a picture shot at 4 pm on March 16 to a completed schedule “Three-day tour at Kaoshung”, the travel record module E2 collects the time information, matches the information with the data relevant to “Three-day tour at Kaoshung” acquired from the system database 4D so as to figure out that the user is scheduled at “Kaoshung true-love harbor” at 4 pm on March 16, and categorizes the shooting location of the photo to the “Kaoshung true-love harbor” accordingly.

For instance, if the user tends to upload the travel record relevant to the location “E-Da World” during the tour of “Three-day tour at Kaoshung”, he/she may click on the option “E-Da World” of the tour “Three-day tour at Kaoshung” in the travel record module E2, so as to perform writing and editing.

After the user has completed the uploading or editing, the travel record module E2 writes inputted travel information and elements such as the photos, travel, food diary, video, audio, notes, clicking record or the combination thereof into photo database 4D21, travel database 4D22 and film database 4D23 of the system database 4D.

When the user uses travel record module E2 to release a travel records information output instruction, the travel record module E2 forwards the above arrangement of travel record parameters to books setting module 4BS, displays the page, automatically enters the books setting module 4BS, and guides the user through the setting operation (step 4012). The books setting module 4BS contains drawings of the front and back covers of the book, edition type, theme color, content categories, the number of pages, size, title, font . . . for the user to choose. The user having selected and confirmed output books, the books setting module 4BS writes the user's settings option to the corresponding sub-databases of the system database module 4D (such as output theme color database 4D18, output of the front and back covers database 4D19, the output version typesetting database 4D20 . . . etc.), and enters the output calculation module CO1, CO2. The system automatically performs calculation. (step 4013)

Notably, in the present embodiment, the user may skip the step set up on the preceding paragraph and instruct the system to jump into the next step, which is system automatic calculating (Step 4013), if the user does not intent to perform books setting.

After the completion of the operation of book setting (Step 4012), according to the present embodiment, if the user chooses to output an printed book, the calculation module CM in the output calculation module (2)CO2 performs calculation (Step 4013) based on contents of the travel schedule inputted by the user (Step 4111), such as photos, travel, food diary, notes, click record . . . etc, and the book setting information (Step 4012), writes the result into the system database 4D, generates books in the electronic formation B1 (Step 4014), and informs the user the prices to by paid for obtaining a printed book obtained from printing out.

If the price is zero, the user skips the payment process. The system calculates through the printing module PM (Step 4016), and generates the form of a printed book B2 (Step 4017). If the price is greater than zero, the user enters the payment process to complete the payment action is calculated (step 4016), resulting in a form of a printed book B2 (step 4017), through the printing module PM.

Among those, the printed books B2 include text documents or books, picture documents or books, picture files mixed into documents or books. In the present embodiment, the present form of the paper can be a combination of the above form of a personalized travel memorial yearbook. The user may obtain the printed books B2 via printing, mail, fax . . . and etc. (step 4018).

### Embodiment 3: Selecting Travel Information and Automatically Outputting Printed Books

Refer to FIGS. 15(a) and (b), a user accesses the travel information selection module E3 in the user input module E (Step 4113). The travel information selection module E3 can read the information relevant to tour location, restaurant, lodge, activities, location of shows, package tours, introduction, open time, traffic route, price, recommendation index, recommended visiting time and etc. provided by firms, companies or personnel from the tour location database 4D11, the restaurant database 4D12, the lodge database 4D13, the tour database 4D14, the tour companion database 4D15 and the traffic route database 4D16 of the system database 4D, and displace the information on the page available to the user.

After the user has completed the selection, the travel information selection module E3 writes the user-selected travel information into databases corresponding to attractions, restaurants, lodging, transportation routes the system database 4D.

When the user uses travel information selection module E3 to release a travel schedule information output instruction, the travel information selection module E3 forwards the above arrangement of travel information parameters to books setting module 4BS, displays the page, automatically enters the books setting module 4BS, and guides the user through the setting operation (step 4012). The books setting module 4BS contains drawings of the front and back covers of the book, edition type, theme color, content categories, the number of pages, size, title, font . . . for the user to choose. The user having selected and confirmed output books, the books setting module 4BS writes the user's settings option to the corresponding sub-databases of the system database module 4D (such as output theme color database 4D18, output of the front and back covers database 4D19, the output version typesetting database 4D20 . . . etc.), and enters the output calculation module CO1, CO2. The system automatically performs calculation. (step 4013)

Notably, in the present embodiment, the user may skip the step set up on the preceding paragraph and instruct the system to jump into the next step, which is system automatic calculating (Step 4013), if the user does not intent to perform books setting.

According to the present embodiment, if the user chooses to output an printed book, the calculation module CM in the output calculation module (2)CO2 performs combination and calculation based on contents of the information such as travel information and books setting inputted by the user, writes the result into the system database 4D, generates books in the electronic formation B1 bearing the travel information (Step 4014), and informs the user the prices to be paid for obtaining a printed book obtained from printing out.

If the price is zero, the user skips the payment process. The system calculates through the printing module PM (Step 4016), and generates the form of a printed book B2 (Step 4017). If the price is greater than zero, the user enters the payment process to complete the payment action is calculated (step 4016), resulting in a form of a printed book B2 (step 4017), through the printing module PM.

Among those, the printed books B2 include text documents or books, picture documents or books, picture files mixed into documents or books. In the present embodiment, the present form of the paper can be a combination of the above form of a personalized travel memorial yearbook. The user may obtain the printed books B2 via printing, mail, fax . . . and etc. (step 4018)

### Embodiment 4: Travel Record Information Being Automatically Outputted and Resulted in a Printed/Electronic Output

Refer to FIGS. 16(a), 16(b), a user first enters the user input module E travel record module E2 to perform the operation of setting travel record group (step 4212).

The travel record module E2 first read travel location database 4D11 restaurant database 4D12, accommodation database 4D13, tours database 4D14, traveling companion database 4D15 and traffic routes database 4D16 in the system database 4D, collects the travel information of what have been completed, such as travel time, travel locations, transportation routes, traveling companion . . . information users through tourism record module E2 upload such photos, travel, food, mind, sounds, videos, annotations, punch card record, or a combination thereof, and performs a matching according to the time and place of the file with the travel information.

For example, the user uploads a photo taken at 9:00 on March 17 to a completed trip of “Three-day tour at Kaoshung”, the travel record module E2 collects the shooting time, compares to the information of “Three-day tour at Kaoshung” obtained from the system database 4D, realizes that user's schedule at 9 o'clock on March 17 is to visit the E-DA World, and accordingly categories the location of this photo to the ““E-DA World” World”.

If the user tends to upload sound/music relevant to the “E-DA World”, he/she may select the location “E-DA World” in “Three-day tour at Kaohsung” of the travel record module E2 and performs sound/music uploading.

After the completion of the user's uploading or writing, the travel record module E2 uploads photos, travel, food diary, sounds, videos, comments, punch record or a combination thereof, and writes into the photo database 4D21, travels database 4D22, movie database 4D23 and etc. of the system databases 4D.

When users uses the travel record module E2 to instruct a travel record information output command, the travel record module E2 forwards the abovementioned arrangement of travel record parameters to the output medium setting module OS page, automatically enters the output medium setting module OS, and guides the user to the output media set the action (step 4022). For the user to select the output medium setting module OS, containing output, the theme color, layout, size, title, font . . . etc., as well as non-interactive output media options.

The non-interactive output medium is one selected from one of the group consisted of a non-interactive electronic form output media and a printed form of output media, in which the non-interactive electronic form output medium is one selected from the group consisting e-mail, e-books, e-one of the groups of the form of documents, electronic form of pictures, videos of the electronic form and in electronic form animation, and the printed output in the form of medium is selected from one of the group consisting the files, books, clothing, mugs, and ornaments.

After the user has selected and confirmed the outputs, the output media setting module OS writes the user-selected settings into corresponding databases (such as output theme color database 4D18, output type version comp database 4D20 . . . ) of the system database 4D, and enters the output calculation modules CO1, CO2. The system automatically performs calculation. (step 4023)

In this embodiment, the user A firstly selects to output photos shot in the “E-DA World” in printed form on clothes. The output the CO2 calculation module (2) reads photos shot in the “E-DA World” selected and uploaded by the user from the system database D. With the output medium set to “clothes” together with information of color, layout, size, title, font . . . and etc, the two settings are jointly calculated, and the results are written to the system database 4D for backup. A non-interactive electronic form output O1 (step 4024), such as a pdf file, is generated, and the user is informed the price to pay for producing clothes with the “E-DA World” photo printed thereon.

If this price payable to zero, the user skips the payment process, and the system calculates through the printing module PM (4026) to produce a printed form of output O2 (step 4027). If the price is greater than zero, the user enters the payment process, completes the payment action, and then through the printing module's PM calculation (step 4026) to produce a printed form of output O2 (step 4027). User A may get this printed output via mail, supermarkets collection site to receive . . . and other ways. (step 4028) The printed output in the form of the O2, User A for example, which is the clothes the photo “E-DA World” printed thereon.

In this embodiment, the user A intends to output an electronic non-interactive output, such as an automatic PowerPoint broadcasting file, bearing user's photo and sound/music in the “E-DA World”. The output calculation module (1) CO1 reads the user-selected “E-DA World” photos and sound/music from the system database 4D, and the output medium is set to “automatic PowerPoint broadcasting file”, as well as other theme color layout, size, title, font and etc. After the two sets are jointly calculated, the results are written into the system database D for backup, and a non-interactive electronic output O1 (step 4024) is generated. The output calculation module (1) CO1 informs the use the price-to-pay for automatically producing a PowerPoint sound/music playback file bearing photos shot in “E-DA World” and relevant sound/music.

If this price payable to zero, the user skips the payment program, and obtain the electronic output O1 following the view and download processes (step 4025), and watch or download the electronic output O1 on user's computer or mobile devices. The user can also download the electronic output O1, and shares the electronic output O1 via e-mail, remote storage device to other sites or blogs.

If the price is greater than zero, the user enters the payment process, completes the payment operation, obtains the electronic form output O1 via view and download processes (step 4025), and watches or downloads this electronic output O1 at the user's computer or mobile device. The user can also download the electronic output O1, and output O1 to share the electronic output O1 via e-mail, remote storage device to other sites or blogs. The electronic output O1, User A for example, is a PowerPoint automatic broadcast file bearing photos and sound/music of the “E-DA World”.

Notably, though the travel record module E2 is taken as an example in this embodiment, an electronic form output O1 or a printed form of output O2 can also be produced by using the travel schedule planning module E1 and travel information selected module E3 to select travel planning information as output through the output media setting module OS output media set (step 4022).

### Embodiment 5: Travel Schedule Being Automatically Outputted as a Printed/Electronic Interactive Interface

Refer to FIGS. 17(a) and (b), a user accesses the travel tour planning module E1 in the user input module E (Step 4111). The travel tour planning module E1 reads the tour location database 4D11, the restaurant database 4D12, the lodge database 4D13, the tour database 4D14, the tour companion database 4D15 and the traffic route database 4D16 of the system database 4D, and the information relevant to tour location, restaurant, lodge, traffic route and etc. is displaced on the user interface for the user to perform a brand new travel tour planning or resume an unfinished planning. When the user has completed the travel tour planning, the travel tour planning module E1 writes the planned travel information and elements such as the location the restaurant, the lodge, the traffic route and etc. arranged in the tour planning into databases corresponding to locations, restaurants, lodge, traffic routes and etc. of the travel schedule database.

When the user gives a travel planning information instructions at the travel schedule planning module E1, the travel schedule planning module E1 forwards planning parameters of the above arrangements to the interactive interface settings module IS page and automatically enters the interactive interface setting module IS and guide the user to perform interactive interface setting operation (step 4032). The interactive interface settings module IS contains output contents, interactive output interface option, pattern, type version, the theme color, number of pages, size, title, font . . . for the user to choose.

When the user has completed the selection and confirmed the output, the interactive interface setting module IS writes the user's setting option to corresponding sub-databases (such as output theme color database 4D18, output type version comp database 4D20 . . . ) in the system database 4D, and enters the output calculation module CO1, CO2 for the system to perform automatic calculation (step 4033).

In the present embodiment, the user B firstly selects the output of his planned itinerary “Hong Kong Shopping Tour” itinerary information, form a mosaic of videos in a Web page to share with friends and travelling companions.

The output calculation module CO1 (1) reads information including itinerary, interactive interface set as “film” and others such as topics color, layout, size, title, font . . . planned by the user as “Hong Kong Shopping Tour” from the system database D, jointly calculates the two set, writes the results into the system database 4D for backup, and generates an electronic interactive interface I1 (step 4034) such as a video file, and informs the user the payment price for producing the film.

If this payment price is zero, the user skips the payment process, obtains the electronic interactive interface I1 via viewing and download process (step 4035), and watches or downloads the electronic interactive interface I1 on the user's computer or mobile devices, or share the electronic interactive interface I1 at other sites or blogs through direct click mosaic of the interactive interface code.

If this payment price is greater than zero, the user enters the payment process to complete the payment action, and then obtains the electronic interactive interface I1 according to view and download processes (step 4035), and watches or downloads the electronic interactive interface I1 (step 4035) to the user's computer or mobile device, or share the electronic form of interactive interface I1 at other sites or blogs through direct click mosaic of the interactive interface code.

The electronic interactive interface I1, User B, for example, is a web page bearing the user's shopping tour itinerary information videos. The web page has interactive features including forward, leaving messages and sharing to community website, and also has available the mosaic to the other pages of the open code.

In this embodiment, the user B also intends to output planned itinerary “Hong Kong Shopping Tour” itinerary information in printed form printed in an interactive pop-up book, and then the output the calculation module (2) CO2 reads the trip itinerary information, the output medium is set to “interactive pop-up book,” as well as other theme color, layout, size, title, font . . . that user has planned for the “Hong Kong Shopping Tour” from the system database, jointly calculates the two, writes the results to the system database 4D for backup, and generates an electronic interactive interface I1 (step 4034), such as a dynamic interactive preview three-dimensional book animation file, and informs the user the price for producing the three-dimensional book.

If this price is zero, the user simply skips the payment process while the output calculation module (2) CO2 calculates the result and forward the result to the printing module PM for calculation (step 4036), and produces a printed interactive interface I2. (4037)

If the price is greater than zero, the user enters the payment process, completes the payment action, the output calculation module (2) CO2 calculates a result and sends the result to the printing module PM for calculation (step 4036), and results in a printed interactive interface I2 (step 4037). User B may get this printed interaction the Interface I2 via mail, supermarkets collection site (step 403 8). The printed interactive interface I2, for example User B, that is printed with a three-dimensional book for the Hong Kong Shopping Tour itinerary planning.

### Embodiment 6: Travel record being automatically outputted to a printed/electronic interactive interface

Refer to FIGS. 17(a) and (b), a user accesses the travel tour record module E2 in the user input module E (Step 4312).

The travel record module E2 firstly reads the location database 4D11, restaurant database 4D12, accommodation database 4D13, tours database 4D14, traveling companion database 4D15, traffic routes database 4D16 in the system database 4D, collects information such as travel time, travel locations, transportation routes, traveling companion and etc. of the trips that have been completed. The user further uploads information such photos, travel, food, mind, sounds, videos, annotations, punch card record, or a combination thereof through travel record module E2, and performs a matching based on the time and place of the file and the itinerary information.

For example, the user uploads a photo taken at four o'clock in the afternoon of March 16 into record of the completed trip of the “Three days at Kaohsiung” tour, the travel record module E2 collects the shooting time, and compares with the information of “Three days at Kaohsiung” tour in to the system database 4D, realized that the user's schedule is at Kaohsiung love Pier at four o'clock in the afternoon of March 16, and then the pictures are categorized to Kaohsiung love Pier.

If the user tends to upload travel relevant to the “E-DA World”, he/she may select the location “E-DA World” in “Three-day tour at Kaohsung” of the travel record module E2 and performs writing and editing to the travel.

After the completion of the user's uploading or writing, the travel record module E2 uploads photos, travel, food diary, sounds, videos, comments, punch record or a combination thereof, and writes into the photo database 4D21, travels database 4D22, movie database 4D23 and etc. of the system databases 4D.

When the user uses the travel record module E2 to instruct a travel record information output command, the travel record module E2 forwards the abovementioned arrangement of travel record parameters to the interactive interface setting module IS page, automatically enters the interactive interface setting module IS, and guides the user to implement the interactive interface setting operation (step 4032). The interactive interface setting module IS contains output contents, the theme color, layout, size, title, font . . . etc. for the user to choose.

When the user has selected and confirmed the output, the interactive interface settings module IS writes the user' option settings to correspond sub-databases (such as output theme color database 4D18, output type version comp database 4D20 . . . ) of the system database 4D, and enters the output calculation module CO1, CO2, to let the system automatically calculate (step 4033).

In this embodiment, the user B firstly selects the output recorded as “Hong Kong shopping tour” to form a mosaic in a web of interactive interface to share with friends and traveling companions. The Hong Kong Shopping Tour record information includes the group travelogues and photos of this trip, the final form of interactive interface contains the schedule of the trip, travelogues, photos. The user can click on certain attractions on the itinerary, display photos of the attractions and travel.

The output calculation module (1) CO1 of reads information of user-planned “Hong Kong Shopping Tour”, such as itinerary planning, travel, photos and interactive interface, from system database 4D, having being set to “itinerary, photos, travels triple interaction interface” and other topics of color, layout, size, title, font . . . information, jointly calculates the two sets of information, writes the results to the system database 4D for backup, produces an electronic interactive interface I1 (step 4034), and informs the user the price for producing the interactive interface.

If this payment price is zero, the user skips the payment process, obtains the electronic interactive interface I1 via viewing and download process (step 4035), and watches or downloads the electronic interactive interface I1 on the user's computer or mobile devices, or share the electronic interactive interface I1 at other sites or blogs through direct click mosaic of the interactive interface code.

If this payment price is greater than zero, the user enters the payment process to complete the payment action, and then obtains the electronic interactive interface I1 according to view and download processes (step 4035), and watches or downloads the electronic interactive interface I1 (step 4035) to the user's computer or mobile device, or share the electronic form of interactive interface I1 at other sites or blogs through direct click mosaic of the interactive interface code.

The electronic interactive interface I1, User B, for example, is a web page bearing the user's shopping tour itinerary, photos and travel information. The web page has interactive features including forward, leaving messages and sharing to community website, and also has available the mosaic to the other pages of the open code.

In this embodiment, the user B also intends to output planned itinerary “Hong Kong Shopping Tour” itinerary information in printed form printed in an interactive pop-up book, and then the output the calculation module (2) CO2 reads the trip itinerary, travel, photos and output medium information, the output medium is set to “interactive pop-up book,” as well as other theme color, layout, size, title, font . . . that user has planned for the “Hong Kong Shopping Tour” from the system database, jointly calculates the two, writes the results to the system database 4D for backup, and generates an electronic interactive interface I1 (step 4034), such as a dynamic interactive preview three-dimensional book animation file, and informs the user the price for producing the three-dimensional book.

If this price is zero, the user simply skips the payment process while the output calculation module (2) CO2 calculates the result and forward the result to the printing module PM for calculation (step 4036), and produces a printed interactive interface I2. (4037)

If the price is greater than zero, the user enters the payment process, completes the payment action, the output calculation module (2) CO2 calculates a result and sends the result to the printing module PM for calculation (step 4036), and results in a printed interactive interface I2 (step 4037). User B may get this printed interaction the Interface I2 via mail, supermarkets collection site (step 403 8). The printed interactive interface I2, for example User B, that is printed with a three-dimensional book for the Hong Kong Shopping Tour itinerary, travel and photos.

### Embodiment 7: Combination Method for Travel Record and Travel Schedule

A user uploads a photo taken at four o'clock in the afternoon of March 16 to its completion of the trip the “Three-day tour at Kaohsiung”. The travel records module E2 learns the time of the shooting, compares with the information related to “Three-day tour at Kaohsiung” from the system database 4D, realizes that user's schedule at 4 pm of March 16 is at Kaohsiung love Pier, and then categorizes the location of the photo to the tourist destination of Kaohsiung love Pier.

In an embodiment, a travelling information outputting method is applied to the personalized travel information automatic output system 160a, wherein the travelling information outputting method includes steps of receiving a travelling information, obtaining an output content describing the travelling information, selecting an output medium, and transforming the output content on the output medium. In another embodiment, the travelling information outputting method further includes a step of outputting the output medium showing the output content thereon, and the output medium is a non-interactive output medium being one of a non-interactive electronic output medium and a printed output medium, wherein the non-interactive electronic output medium is one selected from the group consisting of an e-mail, an electronic book, an electronic document, an electronic figure, an electronic film, an electronic animation and a combination thereof, and the printed output medium is one selected from the group consisting of a document, a book, a cloth, a cup and a decoration

### Embodiments

1. A method for matching information, comprising steps of:

receiving a first specific parameter corresponding to a first group of travel objects;

receiving a first public parameter; and

performing a first calculating operation to generate a second group of travel objects based on the first specific parameter and the first public parameter.

2. The method of embodiment 1, wherein the first public parameter is obtained by pre-evaluating the first group of travel objects.

3. The method of embodiment 1, wherein the first specific parameter is a first personalized preference parameter received from a user's input, the first personalized preference parameter and the first public parameter are transformed into a first personalized preference parameter structure and a first public parameter structure, and the first calculating operation further comprises a step of:

transforming the first personalized preference parameter structure into a second personalized preference parameter structure based on an arithmetic operation.

4. The method of any one of embodiments 1-3 further comprising steps of:

performing a second calculating operation to generate a group of personalized evaluation values corresponding to the first group of travel objects based on the second personalized preference parameter structure and the first public parameter structure; and

performing a third calculating operation on the first group of travel objects to cause respective objects of the second group of travel objects to be arranged in a specific order based on the group of personalized evaluation values.

5. The method of any one of embodiments 1-4, wherein the second calculating operation is one selected from the group consisting of a weighted operation, a relational analysis operation and a combination thereof.

6. The method of any one of embodiments 1-4, wherein the third calculating operation includes a sort operation and is operated based on a public information.

7. The method of any one of embodiments 1-6 further comprising a step of:

generating a third group of travel objects based on the third calculating operation.

8. The method of any one of embodiments 1-7 further comprising steps of:

generating a public evaluation value corresponding to the third group of travel objects based on a second public evaluation parameter structure which is obtained by pre-evaluating the third group of travel objects; and

sorting the third group of travel objects to generate the first group of travel objects based on the public evaluation value.

9. The method of embodiment 1 further comprising a step of:

arranging respective ones of the second group of travel objects in a specific order by performing the first calculating operation, wherein the ones of the second group of travel objects are at least partially overlapped with those of the first group of travel objects.

10. A reserving method, comprising steps of:

arranging a schedule;

obtaining a resource corresponding to the schedule; and

performing a reservation for the resource while arranging the schedule or after finishing the schedule.

11. The method of embodiment 10, wherein the reservation is one selected from the group consisting of a single resource reservation, a partial resource reservation and an all resource reservation, and the method optionally comprises a step of:

performing a cancellation for the reservation, wherein the cancellation is one selected from the group consisting of a single resource cancellation, a partial resource cancellation and an all resource cancellation.

12. The method of embodiment 10 further comprising steps of:

performing an amendment to the schedule; and

adjusting the resource based on the amendment.

13. The method of embodiment 10, wherein the schedule has a scheduling order, and the method further comprises steps of:

receiving a user's determination; and

arranging the scheduling order according to the user's determination.

14. The method of embodiment 10, wherein the schedule includes plural locations, and the method further comprises a step of:

arranging at least one itinerary path for the respective plural locations, and optionally comprises a step of:

arranging a traffic way for the itinerary path.

15. The method of embodiment 10 further comprising a step of:

arranging a budget for the schedule.

16. The method of embodiment 10 further comprising a step of: arranging a backup schedule.

17. A travelling information outputting method, comprising steps of:

receiving a travelling information;

obtaining an output content describing the travelling information;

selecting an output medium; and

transforming the output content on the output medium.

18. The method of embodiment 17 further comprising a step of:

outputting the output medium showing the output content thereon.

19. The method of embodiment 17, wherein the output medium is a non-interactive output medium being one of a non-interactive electronic output medium and a printed output medium.

20. The method of any one of embodiments 17-19, wherein the non-interactive electronic output medium is one selected from the group consisting of an e-mail, an electronic book, an electronic document, an electronic figure, an electronic film, an electronic animation and a combination thereof, and the printed output medium is one selected from the group consisting of a document, a book, a cloth, a cup and a decoration.

Being a precious innovation, the present invention is deeply valuable for the industry, and is applied for a patent in accordance with the law. In addition, any modification can be made to the present invention by the skilled in the art, without departing from the scope of the claims to be protected.

What is claimed is:

1. A method for matching information, comprising steps of:
receiving a first specific parameter corresponding to a first group of travel objects;
receiving a first public parameter; and
performing a first calculating operation to generate a second group of travel objects based on the first specific parameter and the first public parameter.

2. A method as claimed in claim 1, wherein the first public parameter is obtained by pre-evaluating the first group of travel objects.

3. A method as claimed in claim 1, wherein the first specific parameter is a first personalized preference parameter received from a user's input, the first personalized preference parameter and the first public parameter are transformed into a first personalized preference parameter structure and a first public parameter structure, and the first calculating operation further comprises a step of:
transforming the first personalized preference parameter structure into a second personalized preference parameter structure based on an arithmetic operation.

4. A method as claimed in claim 3 further comprising steps of:
performing a second calculating operation to generate a group of personalized evaluation values corresponding to the first group of travel objects based on the second personalized preference parameter structure and the first public parameter structure; and
performing a third calculating operation on the first group of travel objects to cause respective objects of the second group of travel objects to be arranged in a specific order based on the group of personalized evaluation values.

5. A method as claimed in claim 4, wherein the second calculating operation is one selected from the group consisting of a weighted operation, a relational analysis operation and a combination thereof.

6. A method as claimed in claim 4, wherein the third calculating operation includes a sort operation and is operated based on a public information.

7. A method as claimed in claim 6 further comprising a step of:
generating a third group of travel objects based on the third calculating operation.

8. A method as claimed in claim 7 further comprising steps of:
generating a public evaluation value corresponding to the third group of travel objects based on a second public evaluation parameter structure which is obtained by pre-evaluating the third group of travel objects; and
sorting the third group of travel objects to generate the first group of travel objects based on the public evaluation value.

9. A method as claimed in claim 1 further comprising a step of:
arranging respective ones of the second group of travel objects in a specific order by performing the first calculating operation, wherein the ones of the second group of travel objects are at least partially overlapped with those of the first group of travel objects.

10. A reserving method, comprising steps of:
arranging a schedule;
obtaining a resource corresponding to the schedule; and
performing a reservation for the resource while arranging the schedule or after finishing the schedule.

11. A method as claimed in claim 10, wherein the reservation is one selected from the group consisting of a single resource reservation, a partial resource reservation and an all resource reservation, and the method optionally comprises a step of:
performing a cancellation for the reservation, wherein the cancellation is one selected from the group consisting of a single resource cancellation, a partial resource cancellation and an all resource cancellation.

12. A method as claimed in claim 10 further comprising steps of:
performing an amendment to the schedule; and
adjusting the resource based on the amendment.

13. A method as claimed in claim 10, wherein the schedule has a scheduling order, and the method further comprises steps of:
receiving a user's determination; and
arranging the scheduling order according to the user's determination.

14. A method as claimed in claim 10, wherein the schedule includes plural locations, and the method further comprises a step of:
arranging at least one itinerary path for the respective plural locations, and optionally comprises a step of:
arranging a traffic way for the itinerary path.

15. A method as claimed in claim 10 further comprising a step of:
arranging a budget for the schedule.

16. A method as claimed in claim 10 further comprising a step of:
arranging a backup schedule.

17. A travelling information outputting method, comprising steps of:
receiving a travelling information;
obtaining an output content describing the travelling information;
selecting an output medium; and
transforming the output content on the output medium.

18. A method as claimed in claim 17 further comprising a step of:
outputting the output medium showing the output content thereon.

19. A method as claimed in claim 17, wherein the output medium is a non-interactive output medium being one of a non-interactive electronic output medium and a printed output medium.

20. A method as claimed in claim 19, wherein the non-interactive electronic output medium is one selected from the group consisting of an e-mail, an electronic book, an electronic document, an electronic figure, an electronic film, an electronic animation and a combination thereof, and the printed output medium is one selected from the group consisting of a document, a book, a cloth, a cup and a decoration.
